(19) United States
(12) Patent Application Publication
(10) Pub. No.: US 2021/0019996 A1
(43) Pub. Date: Jan. 21, 2021

(54) GAMING SYSTEM AND METHOD PROVIDING FREE SPIN AWARD DISPLAYS

(71) Applicant: ADP GAUSELMANN GMBH, Espelkamp (DE)

(72) Inventor: Michael Charles Halvorson, Las Vegas, NV (US)

(21) Appl. No.: 16/514,482

(22) Filed: Jul. 17, 2019

(51) Int. Cl. G07F 17/32; G07F 17/34

(52) U.S. Cl. CPC G07F 17/3267; G07F 17/3244; G07F 17/34; G07F 17/3213

(57) ABSTRACT

The present disclosure provides systems and processes for gaming and amusement devices. A gaming system consistent with the present disclosure provides a game involving multiple game features. A first feature can include one or more rounds of game play that can award rounds of a second feature. The rounds of the second feature accumulate over multiple rounds of the first feature. Playing the second feature may consume the rounds such that the second feature ends when all rounds obtained by the player from the first feature are consumed.

### FIELD

The present disclosure relates to gaming systems.

### BACKGROUND

Gaming systems accept wagers from players in exchange for opportunities to win awards or prizes. Current gaming systems combine various specialized computing technologies to provide systems adapted to gain the attention of players and to keep them engaged with the gaming systems. To retain players' interest, gaming systems that offer new and unconventional functionality are needed.

### SUMMARY

The present disclosure is directed to systems and processes for gaming. A gaming system consistent with implementations disclosed herein provides a game that randomly determines symbols and displays such symbols to players using a display device. The gaming system evaluates the displayed symbols to determine whether they correspond to predetermined awards.

In accordance with aspects of the present disclosure, a gaming system provides a game involving multiple game features, in which a first feature includes one or more rounds that can award rounds of a second feature. The gaming system may accumulate the rounds of the second feature over multiple rounds (e.g., plays, iterations, attempts, spins, or tries) of the first feature. For example, the game rounds can be rounds of a game provided using a game display (e.g., spins of a slot machine's reels) of the second feature. Playing the second feature may consume the accumulated rounds such that the second feature ends when all rounds are consumed.

In accordance with aspects of the present disclosure, the rounds of the second feature can be free (e.g., require no additional wager from the player) or they may require a wager (e.g., an ante corresponding to a number of pay lines activated). In an example implementation in which the second feature is a slot machine game using game reels, one play of the game (e.g., one spin of the game reels) may consume one free spin (e.g., round). In other such implementations, a number of free spins may be consumed corresponding to a number of pay lines activated for one play of the game. In other such implementations, one free spin may be consumed corresponding to one free pay line activated for one spin of the game reels, and the player may provide additional antes to activate additional pay lines for that spin of the reels.

In some implementations, the first feature of the game is a base game, the second feature of the game is a bonus game triggerable in the base game, and the rounds accumulated in the base game are rounds of the bonus game. In some implementations, the rounds of the bonus game are solely accumulated from symbol values corresponding to game symbols in the base game. In other implementations, the base game may provide the player a baseline quantity of rounds for the bonus game (e.g., 10 plays) and such baseline quantity may be increased by the symbol values corresponding to the game symbols in the base game. In some implementations, the quantity provided as a baseline and the quantities provided by the symbol values varies. For example, different bonus triggers (e.g., combinations of game symbols) in the base game may provide different baseline quantities of the plays in the bonus game. Additionally or alternatively, in some implementations the quantity of plays provided as a baseline or provided by the symbol values in the base game vary in relation to an amount of a wager received from the player for a play of the base game. For example, a larger wager in the base game may provide a greater quantity of rounds in the bonus game than would a lower wager in the base game.

During plays of the base game, the gaming system can randomly determine different combinations of game symbols (e.g., slot machine symbols), display such game symbols in symbol display areas provided on a display device of the gaming system (e.g., symbol display positions in a game screen of a slot machine game display), evaluate displayed game symbols for predetermined winning combinations, and determine awards corresponding to the winning combinations. Additionally, in accordance with aspects of the present disclosure, some or all of the game symbols of the first feature may have corresponding symbol values. The gaming system can display the symbol values together with their corresponding game symbols in the symbol display areas. The symbol values can be fixed values or variable values. For example, in some implementations, the symbol values (e.g., 5, 4, 3, 2, and 1, or other suitable range) may have predetermined, fixed values corresponding to the relative value of the game symbol values (e.g., Ace, King, Queen, Jack, and Ten, or other game symbols). In some implementations, the symbol values are fixed values that are independent of the relative value of the game symbol values. Also, in some implementations, the gaming system can randomly determine the symbol values. For example, the gaming system can determine the symbol values of the game symbols by randomly selecting them from a predetermined range of values (e.g., 1-5, or other suitable range).

In some implementations, the gaming system may incrementally increase the symbol values from an initial value at the start of a gaming session. For example, in the first play of the first feature in a gaming session, a symbol value corresponding to a game symbol may have an initial value of “1,” for a second play of the first feature, the gaming system may incrementally increase the symbol value associated with that same game symbol to “2,” for a third play of the first feature, the gaming system may incrementally increase the symbol value associated with that same game symbol to “3,” and so on. Also, in some implementations, the symbol values may for some or all of the game symbols may be capped to a maximum value. Such cap may be different for different game symbols. It is understood that other values and increments for the symbol values may be used and that such values and increments may be different for different game symbols.

Further, in accordance with aspects of the present disclosure, for the individual plays of the first feature, the gaming system can combine symbol values corresponding to the displayed game symbols. In some implementations, the gaming system combines all of the symbol values of the displayed game symbols. In other implementations, the gaming system only combines the symbol values of the displayed game symbols included in active winning pay lines of the symbol display areas. In other implementations, the gaming system only combines the symbol values of displayed game symbols included in winning combinations of game symbols in active pay lines. In other implementations, the gaming system only combines the symbol values of displayed game symbols included in winning combinations of game symbols included in active pay lines.

In some implementations, the gaming system triggers the second feature as a bonus game in the event that predetermined symbol combinations are displayed in the first feature (e.g., a base game). For example, a predetermined symbol or combination of symbols displayed along an active pay line, displayed in a particular game reel, or displayed in particular symbol display areas may trigger the bonus game (e.g., five horizontally-aligned trigger symbols or three vertically-aligned trigger symbols). During plays of the bonus game, the gaming system can randomly determine different combinations of bonus game symbols (e.g., slot machine symbols) for each play of the bonus game, display such game symbols in symbol display areas provided on a display device of the gaming system, evaluate the displayed combinations of bonus game symbols for predetermined winning combinations, and determine awards corresponding to the winning combinations of bonus game symbols.

Further, in some implementations, the bonus game symbols can correspond to an additional bonus game award. For example, predetermined combinations of certain bonus game symbols may include jackpot symbols that provide a jackpot award. In some implementation, the jackpot award can be a progressive jackpot award. In some implementation's, the jackpot symbols can be accumulated over the multiple plays of the bonus game. For example, the jackpot symbols can be persistent symbols that, one displayed in symbol display areas of a game screen, remain locked in the symbol display areas from round-to-round such that they that accumulate during the multiple rounds of the bonus game. In some implementations, the jackpot awards are based on predetermined combinations or arrangements of the jackpot symbols. For example, a jackpot award may be determined when one or more sequences of jackpot symbols are displayed in adjacent symbol display areas.

In accordance with aspects of the present disclosure, the gaming system can be one of a number of gaming systems in communication with a bonus award server (e.g., a progressive bonus controller). For example, the gaming system may be one of several gaming systems in a bank of gaming systems that provide different base games and bonus games (e.g., games having game symbols corresponding to different themes, symbology, processes, odds of winning, pay tables, or return to player percentages) but substantially similar persistent indicators (e.g., persistent indicators corresponding to the same processes, odds, and return to player percentages, but some different themes and symbology). In implementations, the bonus game can provide one or more progressive bonus awards accumulated from wagers placed at the linked gaming systems, and any one of the linked gaming systems can win some or all of the progressive bonus awards. In some implementations, the bonus award server provides a single progressive bonus award that is awarded based on particular combinations of game symbols being displayed upon completion of the second feature game (e.g., upon consumption of all plays of the bonus game).

As described above and set forth in greater detail below, gaming systems in accordance with aspects of the present disclosure provide a specialized computing device integrating non-generic hardware and software that improve upon the existing technology of human-computer interfaces by providing unconventional functions, operations, and symbol sets for generating interactive displays and outputs. The features of the gaming system provide a practical implementation that improves the operation of the gaming systems for their specialized purpose of providing entertainment by reducing player disappointment with game outcomes, by enhancing player enjoyment, and by increasing player engagement.

In some implementations, the features described herein technically improve the operation of gaming systems for their specialized purpose by merging multiple game features (e.g., game rounds, game stages, or sub-games) into a single game presented on a common game screen so that the overlapping game features operate in cooperation, rather than operating in isolation. Merging the multiple game features so they overlap and cooperate in a common game screen technically improves some implementations of the gaming system by reducing the display area used by the gaming system. Thereby, such implementations of the gaming system can reduce power consumption in comparison to gaming systems that use, for example, a display area to display a base game, and a different display area to display a substantially separate bonus game. Further, doing so can reduce the physical complexity and manufacturing cost of the gaming systems in some implementations by reducing the number or size of display devices used by the gaming systems.

Additionally, the features of the gaming system technically improve the operation of the gaming systems for their specialized purpose by providing unique combinations of functions that link game features having multiple rounds. Linking two or more game features together allows games initiated by gaming systems in accordance with the present disclosure can be completed more quickly than systems that provide such games separately. By doing so, the disclosed gaming systems can increase the usage rate (e.g., duty cycle) of the gaming system by allowing more games to be completed in a shorter time period (e.g., games per hour) and by reducing power consumed during a single game (e.g., one play of the game). When such speed and efficiency improvements are applied in the hundreds or thousands of game evaluations performed over time by multiple installations of the gaming system (e.g., multiple devices installed at a casino), implementations of the disclosed gaming system provide game operators substantial improvement in gaming system efficiency.

### BRIEF DESCRIPTION OF THE DRAWINGS

FIG. 1 shows a perspective view illustrating an example gaming system in accordance with aspects of the present disclosure.

FIG. 2 shows a functional block diagram illustrating a game controller and gaming system in accordance with aspects of the present disclosure.

FIG. 3 illustrates an example of an environment for implementing systems and processes in accordance with aspects of the present disclosure.

FIG. 4A shows a process flow diagram illustrating an example method of operating the gaming system in accordance with aspects of the present disclosure.

FIG. 4B shows a process flow diagram illustrating an example method of operating the gaming system in accordance with aspects of the present disclosure.

FIG. 4C shows a process flow diagram illustrating an example method of operating the gaming system in accordance with aspects of the present disclosure.

FIG. 4D shows a process flow diagram illustrating an example method of operating the gaming system in accordance with aspects of the present disclosure.

FIG. 5A shows a picture of a game screen displayed by a gaming system in accordance with aspects of the present disclosure.

FIG. 5B shows a picture of a game screen displayed by a gaming system in accordance with aspects of the present disclosure.

FIG. 5C shows a picture of a game screen displayed by a gaming system in accordance with aspects of the present disclosure.

FIG. 5D shows a picture of a game screen displayed by a gaming system in accordance with aspects of the present disclosure.

FIG. 5E shows a picture of a game screen displayed by a gaming system in accordance with aspects of the present disclosure.

FIG. 5F shows a picture of a game screen displayed by a gaming system in accordance with aspects of the present disclosure.

FIG. 5G shows a picture of a game screen displayed by a gaming system in accordance with aspects of the present disclosure.

FIG. 5H shows a picture of a game screen displayed by a gaming system in accordance with aspects of the present disclosure.

FIG. 5I shows a picture of a game screen displayed by a gaming system in accordance with aspects of the present disclosure.

FIG. 5J shows a picture of a game screen displayed by a gaming system in accordance with aspects of the present disclosure.

FIG. 5K shows a picture of a game screen displayed by a gaming system in accordance with aspects of the present disclosure.

### DETAILED DESCRIPTION

The present disclosure provides systems and processes for gaming and amusement devices. As detailed previously herein, a gaming system consistent with the present disclosure provides a game involving multiple game features, in which a first feature awards rounds (e.g., plays, iterations, attempts, spins, or tries) for a second feature of the game. In some implementations, the first feature can include multiple rounds, and the rounds of the second feature can accumulate over the multiple rounds. Playing the second feature may consume the rounds such that the second feature ends when all rounds obtained by the player during the game are consumed.

### Gaming Device Platform

The features and advantages of the systems and methods described herein may be provided to a player via a gaming system that includes various structures and components for allowing player interaction with the gaming system. While one example of a gaming system is primarily described in detail herein, it is understood that the features, objects, and advantages of the gaming system described herein may be implemented in one or more alternative gaming systems.

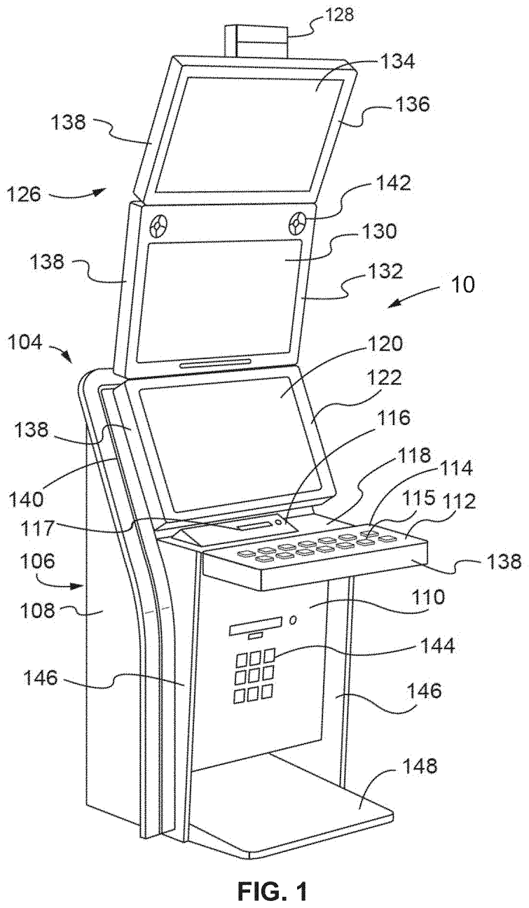

FIG. 1 shows a perspective view illustrating an example of gaming system 100 in accordance with aspects of the present disclosure. Such gaming system 100 may be referred to as a slot machine and, as illustrated, is housed in a cabinet 105 (e.g., a housing) constructed so that a player can operate and play the gaming system 100 while standing or sitting. The cabinet 105 can include a lower cabinet body portion 106, which includes a pair of cabinet side panels 108 (only one of which is viewable in the perspective view of FIG. 1), a front panel 110, and a rear panel (not shown). Additionally, a base panel (not shown) and a top panel surface (not shown) may support a first game display device 120 and the player interaction area 112. The cabinet panels 105, 106, 108, 110 (as well as the base panel and the top panel surface) may be interconnected along their edges and cooperate to form the cabinet 105, which encloses and houses components of the gaming system 100, as can be seen in FIG. 1. The cabinet 105 may function to securely protect local control system, technology components, and provide support for game display(s) and player input and output interactions with the gaming system 100, such as describe herein below.

While the example cabinet 105 is depicted as having a particular shape, structure, and organization, it should be appreciated that a wide variety of cabinet enclosure sizes, shapes, and designs are possible for the gaming system 100. For example, the cabinet panels 105, 106, 108, 110 (as well as the base panel and the top panel surface) may be combined into fewer elements or divided into additional elements. Additionally, the positions of the displays (e.g., first display device 120) and input/output devices can be reorganized and/or relocated with respect to one another.

In accordance with aspects of the present disclosure, a player can interact with the gaming system 100 in various ways to direct the wagering and game play activities and preferences. More specifically, the cabinet 105 includes input and output areas generally designated as the player interaction area 112. The player interaction area 112 may be located on the front top side of cabinet 105 and, as shown, on a panel structure that extends outwardly from the gaming system 100 in a player's direction. The player interaction area 112 may contain player input and output structures, including a player control area 114, a player value acceptor and dispenser area 116, and player convenience input area 118.

The player control area 114 includes one or more input devices 115, such as buttons and touch sensitive areas, through with which players may interact with the gaming system 100 so as to direct game play. It is expected that the cabinet 105 provides an easily accessible location and support for player input/output (I/O) interactions with the gaming system 100, including gaming control interactions and value wagering interactions. Although the gaming system 100 illustrated in FIG. 1 shows the input devices 115 of the player control area 114 as physical controls (e.g., buttons), it is understood that in some implementations, a player's gaming control interactions could be made by either the physical controls or functionally equivalent “soft” controls (e.g., soft buttons) located on the gaming display and activated by player touch (e.g., touch screen interfaces), or a combination of both arrangements.

The input devices 115 may include the following: game selection button(s) in any implementation where more than one game is provided in a single gaming system 100; gaming denomination value selection button(s) in any implementations where one or more wagering denomination value is accommodated; wager selection button(s) for the player to indicate or select the desired wager value for a game in any implementations where a selection of wager values are offered; pay line selection button(s) for selecting the number of active pay lines in game implementations that provide multiple pay line wagering; a reel spin button for players to initiate one or more reels to spin in a game; a repeat last bet button for players to conveniently repeat the last game's preference and wager selections in a new game; a cash-out button for player extraction of gaming device credits; an attendant call button; and gaming device information buttons such as show pay tables, show game rules, or show other game-related information.

The player value acceptor and dispenser area 116 may include one or more value acceptance and value distribution devices 117 that allow the player to interact with the gaming system 100 and to risk or otherwise place a wager (a monetary value) on one or more outcomes of a game. The value acceptance and value distribution devices 117 may return winnings to the player via some form of value distribution. In the player value acceptor and dispenser area 116, a player can supply monetary value to the gaming system 100 via the value acceptance and value distribution devices 117. In some implementations, the value acceptance and value distribution devices 117 may accept any one or more of the following from a player to establish a gaming credit balance: coins, bills, tokens, tickets/vouchers, player ID cards, credit cards, or other suitable forms of value. Thus, if the gaming system 100 accepts coins and bill, the value acceptance and value distribution devices 117 may comprise a currency bill validator and a coin validator. Likewise, if the gaming system 100 accepts tickets, the value acceptance and value distribution devices 117 may comprise a ticket acceptor that receives tickets or vouchers representing some monetary value. The ticket acceptor may include a bar code reader, or other appropriate code reader, for reading the encoded value contained by the player's ticket or voucher. In some implementations, value acceptance and value distribution devices 117 can accept more than one type of value. In some implementations, the player value acceptor and dispenser area 116 may include multiple different value acceptance and value distribution devices 117 that accept different types of value from players.

Upon receipt of some type of value from the player, the value acceptance and value distribution devices 117 of the player value acceptor and dispenser area 116 can perform validation on the player supplied value using appropriate hardware readers (e.g., determining that the currency bills/coins/tokens are genuine or the ticket/voucher is genuine). If the validation result is positive on player supplied value, the value acceptance and value distribution devices 117 can generate a signal to a processor of the gaming system 100 that establishes a gaming credit balance for playing one or more games on gaming system 100.

In some implementations, the value acceptance and value distribution devices 117 dispenses a monetary value, or a representation thereof, from the gaming system 100 when a player chooses to “cash out” the gaming credit balance (e.g., remove value from the gaming system 100). The player can cash out at any suitable time. When a player cashes out the value contained on a credit meter (not shown) of gaming system 100, a processor of gaming system 100 may cause a printer included in the value acceptance and value distribution devices 117 to print and dispense a coded ticket or voucher through a dispensing slot to the player. The coded ticket or voucher may be a bar-coded ticket or any other suitable code (PDF517 coding or quick response (QR) coding). This ticket can then be used as value input at another gaming device, or converted to currency at a conveniently located kiosk or cashier counter located near the gaming device. Alternatively, the processor of gaming system 100 may cause a currency bill dispenser or a coin dispenser included in the value acceptance and value distribution devices 117 to dispense the value contained on the credit meter of gaming system 100.

Various combinations of the above value acceptance and value distribution arrangements are possible. The gaming system 100 may include other value acceptance and value distribution mechanisms in the player value acceptor and dispenser area 116. For example, the value acceptance and value distribution devices 117 may include a magnetic strip or chip card reader/writer in order to accept value from and transfer value to a magnetic strip or an embedded chip card. In other implementations, the value acceptance and value distribution devices 117 may include hardware for transferring (and receiving) non-traditional currencies to players such as digital currencies (e.g., bitcoin).

In some implementations, the value acceptance and value distribution devices 117 may include a card reader that accepts and reads any of a variety of magnetic strip or imbedded chip smart cards that convey machine readable information. The card reader reads inserted cards, in the case of wagering, for the credit information of the player for cashless gaming. The card reader may, for player loyalty programs, utilize the information on the card to identify the player account associated with the card so the gaming activity on the gaming system 100 may be associated with the player account. Additionally, a numeric or alphanumeric keypad (not shown) may be provided adjacent to the card reader slot that enables player entry of a personal identification number or the like for secure access to card information.

In some implementations, a player convenience input area 118 may be included in the gaming system 100, as is shown in FIG. 1. In various implementations, player convenience input area 118 may have a variety of features and functions depending on the jurisdictional deployment of the gaming system 100. In some implementations, the player convenience input area 118 may house a magnetic strip card reader (not illustrated), integrated circuit chip card reader (not illustrated), or both, for reading cards associated with a player loyalty program. Player loyalty programs, also referred to as player tracking systems, provide magnetic strip or chip cards to players for insertion into the gaming system 100 during play. These player loyalty/players tracking cards may be associated with a player account and are utilized by the card-issuing entity to monitor, or track a player's gaming activity and build loyalty through player rewards of a variety of types. The player convenience input area 118 may include an input mechanism such as input buttons so that a player may input a personal identification number or other require player information associated with the player tracking card. Further, the input mechanism may also include a small display utilized to communicate player information to the player such as the player's current loyalty rewards.

In certain implementations, the player convenience input area 118 may include player convenience features such as a pocket for storage that allows players to store their personal items such as a mobile phone. The gaming system 100 may include one or more universal serial bus (USB) ports that enables a player to charge their electronics or connect to services such as the Internet or food service. Further, player convenience input area 118 of the gaming system 100 may include buttons to request food or drink service if the gaming device is located in an establishment that has food and drink service. The gaming system 100 may be connected to a local or wide area network such that selection of the requested food or drink service may alert the establishment's hospitality staff to deliver the requested service directly to the gaming system 100.

The layout of the player control area 114, player value acceptor and dispenser area 116, and the player convenience input area 118 in gaming system 100 may be arranged differently than those disclosed and illustrated herein. The selections and arrangement of input locations on the cabinet 105 may be dependent upon the game buttons, the type of value wagered, and the player conveniences utilized in the deployment configuration of gaming system 100.

In some implementations, the lower cabinet body portion 106 includes the first game display device 120, which can be mounted atop or flush with a top panel surface of the lower cabinet body portion 106. The first game display device 120 can be, for example, a 27-inch liquid crystal display (LCD) display mounted in a widescreen orientation. However, any suitable display may be used in any suitable orientation. In the illustrated implementation, the first game display device 120 can mounted within and framed by first display frame 122 which is, in turn, mounted upon lower cabinet body portion's top panel surface. In this manner, the first game display device 120 is both surrounded and secured within the first display frame 122 and raised above the cabinet's top panel surface. Additional features of the first display frame 122 are described below. In some implementations, the gaming system 100 may use a single first game display device 120 and not include additional game displays (not illustrated). For example, a single first game display device 120 may span the one or more portions of the cabinet 105 (e.g., lower body cabinet portion 106 and upper body cabinet portion 126, described below) in place of other display devices (e.g., display devices 130 and 134, described below).

The lower cabinet body portion 106 can be further constructed to support an upper cabinet portion 126. The upper cabinet portion 126 may be comprised of an upwardly extending support structure (not illustrated) that extends upwardly from the rear side of lower cabinet body portion 106 configured to mechanically support one or more additional game display devices.

At the topmost end of the support structure, a cabinet top light 128 may be provided. The cabinet top light 128 is capable of illumination in a variety of colors and is utilized to indicate and communicate conditions of the gaming system 100 to gaming players and service personnel.

Further, the upper cabinet portion support structure may conceal power and communication lines between (1) the control systems and components located within the lower cabinet body portion 106 and (2) the displays mounted on the upper cabinet portion 126 support structure.

In some implementations, as illustrated in FIG. 1, gaming system 100 includes additional displays, including a second game display device 130 and a third game display device 134. The second game display device 130 and the third game display device 134 can be disposed generally in a vertical relationship and generally in alignment with the first game display device 120. Like the first game display device 120, the second game display device 130 and the third game display device 134 can be 27-inch LCD displays and can be mounted in a widescreen orientation in some implementations. However, any suitable display in any suitable orientation may be used for the second game display device 130 and the third game display device 134. Further, like the first game display device 120, the second game display device 130 and the third game display device 134 can be mounted within and framed by second display frame 132 and third display frame 136, respectively. The second display frame 132 and the third display frame 136 can be attached to the upper cabinet support structure and can protect the second game display device 130 and the third game display device 134.

The first game display device 120, the second game display device 130, and the third game display device 134 can be disposed at an angle from each other to form a player-facing concave arc. However, in some implementations, the angles between the displays 120, 130, and 134 may be adjustable and may be smaller or greater than the angles illustrated in FIG. 1. Further, it is understood that in some implementations the displays may be disposed in a common plane relative to each other.

It also should be appreciated that in various implementations a variety of display technologies may be utilized equivalently and interchangeably with a variety of implementations of the gaming device. Equivalent display devices include all variations of liquid crystal displays, light emitting diode displays, and plasma displays.

In some implementations, different sized displays may be combined to display gaming data on gaming system 100. As a non-limiting example, a 27-inch widescreen LCD display may be combined with a 20-inch portrait-oriented LCD or a light emitting diode (LED) display. This combination may be used, for example, with a third scrolling banner LED display. In alternative implementations, one, two, three, or more displays could be used in a variety of positions and orientations. Any suitable combination may be used. It should also be appreciated that a processor of gaming system 100 may communicate with the disclosed first game display device 120, second game display device 130, and third game display device 134 through a video card of gaming system 100 to produce the visible aspects of a game.

In some implementations, one or more of the first game display device 120, the second game display device 130, and the third game display device 134 may be fitted with a transparent touch sensitive overlay for sensing player touch inputs into the gaming system 100. The touch sensitive overlays can communicate with a processor of gaming system 100 to enable the player to interact with the game.

In some implementations, the curved displays may be used for any or all of the first game display device 120, the second game display device 130, or the third game display device 134. Similarly, any of the displays used for gaming system 100 can be based on flexible display technologies. For example, it is possible to utilize flexible display technologies to create uniquely shaped curving, wavy, or tubular display structures to provide one or more of the first game display device 120, the second game display device 130, and the third game display device 134. Additionally, in some implementations flexible display technologies can be used in combination with fixed flat screen technologies.

While the gaming system 100 has been described as implemented with video technologies, in some implementations, mechanical game reels with reel strips containing game indicia and step motor controllers may be employed to provide game information to a player. In some implementations, the reel strips may include printed symbols. In another implementation, the mechanical game reels may include flexible video display technology as the reel strips on mechanical game reels. Thus, games implemented in video form can readily be implemented with mechanical game reels utilizing such display technology. Alternatively, in other implementations mechanical game reels with reels strips having fixed symbols displayed along the reel strip could be used to implement the game.

Dependent upon the particular gaming device housing style, a variety of other display technologies may be utilized in combination with the gaming device disclosed herein. For example, the gaming system 100 may have one or more display devices in addition to the main game display devices(s) in some implementations. For example, the gaming system 100 may include a player tracking device having a player tracking display which displays various information to the player regarding the player's status. The gaming system 100 may also include other game-related displays such as the wager display and the gaming credit balance display. These additional game-related displays may be separate display devices or may be displayed on any one or more of the first game display device 120, the second game display device 130, or the third game display device 134.

The gaming system 100 may also include cabinet lighting design functions to attract players. In the example gaming system 100 illustrated in FIG. 1, attractive cabinet lighting is provided by frame accent lighting 138. It is noted that frame accent lighting 138 is a common structure found on the first display frame 122, the second display frame 132, and the third display frame 136 and player interaction area 112. Example areas where frame accent lighting is applied to the gaming system 100 are commonly designated as frame accent lighting 138.

Frame accent lighting 138 may have multiple components. The side edge pieces of first display frame 122, second display frame 132, third display frame 136, and the edge structure of player interaction area 112 can be made of a translucent or transparent plastic or other suitable materials. Linear arrays, or strips, of light emitting diodes (LEDs) (not shown) on circuit boards may be mounted below the translucent or transparent plastic side edge pieces. In some implementations, the circuit boards are flexible circuit boards. These LED strips and transparent or translucent coverings may surround one or more gaming device displays frames, as well as the player interaction area, to highlight these areas.

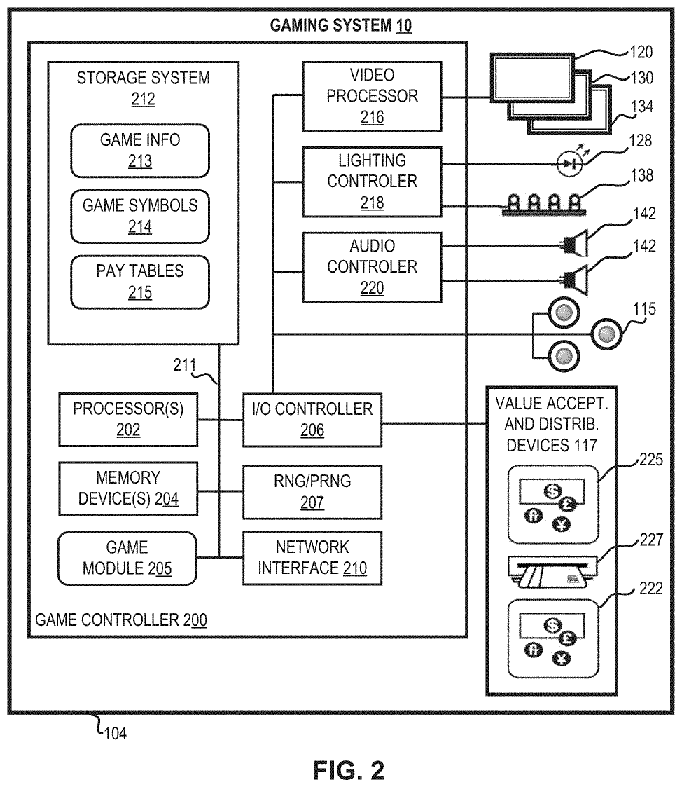

In some implementations, the individual LEDs mounted on the LED strips are of a type that can emit red, green, and blue light. In an alternative implementation, separate LEDs are used for the light colors. All LED strips can be electrically connected and can be controlled by a cabinet lighting controller (e.g., cabinet lighting controller 218 in FIG. 2) in conjunction with a processor of the gaming system 100 to selectively mix the emitted light colors in a manner to create any color. The cabinet lighting controller can flash and vary lighting as desired. For example, cabinet edge lighting can change and flash in combination with music rhythms or in combination with game events. Other variations are possible.

In some implementations, cabinet 105 may include LED strip lighting or LED rope lighting to accentuate the cabinet and enhance the attractiveness of the gaming system 100 to players. LED rope lighting is a number of small light-emitting diode bulbs linked together and encased in a plastic, polyvinylchloride, or other suitable material to create a string of lights. For example, in one implementation illustrated in FIG. 1, cabinet 105 includes cabinet accent lighting 150. In some implementations, cabinet accent lighting 150 is LED rope lighting mounted flush with the front side edge of the cabinet side panels 108. The LED rope lighting can generate any of suitable colors, and are controlled by cabinet lighting controller and a processor of gaming system 100 to selectively mix the emitted light colors in a manner to create any color in the same manner as the frame edge lighting.

In various implementations, gaming system 100 includes one or more audio speakers 152 and appropriate driving electronics and sound cards so that game players may experience pleasing audio aspects of the gaming system 100. Audio is desirable to attract and maintain player interest in gaming system 100. The gaming system 100 may also emit attraction sounds during any idle period of gaming system 100. Game audio may add to the player's enjoyment of gaming system 100 by providing music and sound effects designed to enhance and compliment the gaming experience. In FIG. 1, the audio speakers 152 are shown mounted on the upper corners of second display frame 132. Any suitable number of additional audio speakers 152 may be provided on additional display frames or on the lower cabinet body portion 106 as desired.

The audio speakers 152 designed for emitting bass vibrations may be included in some implementations. Placement of the audio speakers 152 may be selected to enhance the sound emitting characteristics of the gaming system 100. For example, bass speakers or additional speakers 155 may be mounted inside lower cabinet body portion 106. Further, it is envisioned that in some implementations sound processing such as multichannel processing and surround sound processing are included in gaming system 100. Audio jacks for attachment of player headphones may also be provided in some implementations of gaming system 100 for the player to further enhance the audio experience of the game and also to block out noise from other gaming devices.

In some implementations, the front panel 110 of lower cabinet body portion 106 includes a locked removable panel or locked door (not shown), which can be opened for access to internal control system and technology components that are housed within lower cabinet body portion 106 (discussed hereinbelow with respect to FIG. 2). Front panel 110 may be flanked on vertical sides by cabinet side panel extensions 156 which serve to define a space below player interaction area 112 for players to place their feet and legs while they are playing the gaming system 100 in a seated position. Foot rest 158, which may be cushioned, is provided below player interaction area 112 to enhance a player's ergonomic comfort while playing the gaming system 100. In some implementations, the edges of player interaction area 112 may be ergonomically cushioned as well.

The gaming system 100 may be embodied in alternative gaming device housing forms and styles. For example, the housing may have fewer or greater number of display areas for displaying the game and game-related information to the player. If multiple displays are used, the displays may be of similar size, shape, and orientation or the displays may be divergent from each other in one or more of their respective descriptive characteristics. The one or more displays can be supported by, mounted upon, or housed within a cabinet 105 which can comprise a variety of shapes, sizes, and forms. The cabinet 105 can: protect and house the operational electronics; adequately support the display(s) in a position easily viewable for a seated or standing player, as necessary; and/or provide an easy location and support for all necessary player input/output (I/O) interactions, including gaming control interactions and value wagering interactions. For example, in some implementations the gaming system 100 may be disposed in a housing style referred to as a “slant top” gaming device that is designed to be operated with the player comfortably seated. In this arrangement, generally, the gaming display(s) and all player I/O controls are located on a low, wide, surface that extends forwardly from the player on a horizontal plane and then slopes upwardly and away from the player's seated location.

In some implementations, housing styles of cabinet 105 of gaming system 100 may include bar top or table top housing arrangements. These housings are generally small enough to be placed on top of an existing bar or table while providing the requisite gaming device housing functions of protection of/access to gaming electronics, displays, and player I/O functions described above.

In some implementations, cabinet 105 may be an embedded housing. Embedded housings are built into structures designed to otherwise function as bars or tables in a gaming environment. Displays may be integral with the bar top or table top surface or the entire unit may be contained below a transparent bar or table top surface while controls are disposed on the lower front or side of the bar or table.

FIG. 2 shows a functional block diagram illustrating an example of a game controller 200 of a gaming system 100 in accordance with aspects of the present disclosure. The gaming system 100 can include a cabinet 104, one or more player input devices 115, one or more value acceptance and distribution devices 117, one or more display devices 120, 130, and 134, a cabinet top light 128, accent lighting 138, and one or more audio speakers 152, which can be the same or similar to that previously described herein. Additionally, implementations of the game controller 200 includes one or more processors 202, one or more memory devices 204 (e.g., random access memory and read only memory), a game module 205, an input/output (I/O) controller 206, a random number generator 207, a network interface 210, a communication channel 211 (e.g., a data bus), a video processor 216, a lighting controller 218, and an audio controller 220. In accordance with aspects of the present disclosure, the game controller 200 is configured to perform specialized game functions and operations, consistent with the implementations described herein. The functional elements shown in FIG. 2 cooperate, on a broad and general level, to function as a gaming system providing the functionality and operations detailed below. Such functionality and operations can be embodied in hardware, software, or a combination thereof. It is understood that the below described hardware includes the structures described, as well as the functional or operational equivalents of such structures. Further, it is understood that the below-described functions can be performed by hardware, digital circuitry, computer software, computer firmware, or functionally equivalent combinations thereof.

The processor 202 can be one or more general-purpose processors, special-purpose processors, or other programmable data processing apparatuses providing the functionality and operations detailed herein. In some implementations, the processor 202 is specially configured with arithmetic logic units and math co-processors, also known as floating point units, for performing the gaming consistent with the various implementations disclosed herein. In some implementations, the processor 202 includes registers for holding instructions or other data, and cache memory for storing data for faster operation thereupon.

A controller, in some implementations, is a device or a software program that manages or directs the flow of data between two entities. Often, controllers are special purpose circuitry or software that solve a technical communications problem between different technology systems. In some implementations, a controller functions as an interface between two systems while managing the communications between the systems. In another implementation, a controller functions as an interface between a processor and a peripheral device and functions to control the peripheral device.

The memory device 204 can be operatively and communicatively connected to the processor 202. In some implementations, the memory device 204 includes one or more types of memory structures. For example, the memory structures can include random access memory (RAMs) units, read only memory (ROMs), flash memory (e.g., solid state drives (SSDs)), and electrically erasable/programmable read only memory (EEPROMs). It should be appreciated that in some implementations, communication with the memory device 204 by the processor 202 or a controller, encompasses the processor or controller accessing the memory device 204, exchanging data with the memory device 204, or storing data to the memory device 204.

The memory device 204 may store program code, game code (collectively the “code” or “program instructions,” such as game module 205), and operational data (e.g., game info 213, game symbols 214, and pay tables 215) used in the operations of the game controller 200 to provide a gaming system that executes the gaming functions described hereinbelow. In an alternative implementation, the code and operational data for the operation of the game controller 200 may be stored in a distributed manner such that some code is stored in memory device 204 (or storage system 212) and other code is stored remotely from the game controller 200. In some implementations, the code and operational data used the operation of the game controller 200 includes, for example, basic input and output function data, instruction fetching data, bus and network communication protocol data, and like data for an operational gaming device. In some implementations, the code (e.g., game module 205) and operational data (e.g., game info 213, game symbols 214, and pay tables 215) used for the execution of the gaming features includes, for example, game image data, game rule data, pay table data, game mode and timing data, gaming value and wager parameter data, and random or pseudo-random number generation data.

In addition to the memory device 204 described above, in some implementations, the code and operation data for the operation of the gaming device described above may be stored in storage system 212. The storage system 212 can be removable game cartridges or flash drives, a compact disk ROM, a digital versatile disk (DVD) optical storage technology, or suitable other fixed, non-transitory computer-readable storage devices. In another implementation, part or all of the code and operational data for operation of the gaming device or for execution of the game features may be stored in a remote memory structure and be downloaded to the memory device 204 via a network connection.

In some implementations, the game controller 200 may utilize any combination of computer-readable memory devices, such as random-access memory devices (RAMs), unalterable memory devices (ROMs), and mass storage devices for securely storing and securely communicating the software components or code that facilitate game play and other functions of the game controller 200. The memory devices may store software components or code that include various game data and game related control and execution software. In some implementations, the software components stored in the memory devices 204 may include gaming system initialization software, system basic input and output software, operating system software, value acceptor software, value dispenser software, display image generation software, game symbol set image generation software, game rule execution software, game data set(s), random number generation software, system driver software, system data bus management software, audio generation and speaker driver software, and video generation and display driver software, and any other suitable software routines for operation of the game controller 200.

In some implementations, memory devices, such as memory device 204 and storage system 212, with the software components and other data may be secured and authenticated by authentication software stored in an unalterable memory device within the housing of the game controller 200. The game controller 200 may also include application specific integrated circuits (ASICs) to perform the security and authentication functions. At various time or events, such as before each play of a game, at a predetermined interval, upon transfer of any game data or any software components from a mass storage to the memory device 204, or upon demand, the game controller 200 (using a processor such as processor 202 or a separate ASIC) may execute an authentication routine and perform an authentication of any software component or other data of the game controller 200. In some implementations, the gaming device software components may be prepared for authentication via creation and storage of an encrypted signature unique to one or more of the software components.

In some implementations, an encrypted signature may be created by utilizing a hash function on a software component or code to form a message digest (i.e., a hash of the software component) followed by a key encryption of the message digest to form an encrypted signature unique to the software component. In some implementations, the key encryption may be public key encryption, private key encryption, or any suitable key encryption schema. The encrypted signature may be stored with the gaming device software component, for example, in a mass storage device or an unalterable memory. During a software component authentication, the gaming system 100 executes one or more authentication routines utilizing the same hash function to operate on the software component to compute, or re-create, a new message digest for the software component. The new or re-created message digest may then be compared with a previously created message digest obtained by decrypting the stored encrypted signature. Matching message digests between the new and previously created message digests indicate that the software component is authentic and the game controller 200 may allow game play to proceed. However, when the message digests do not match, the game controller 200 may determine that the software component under authentication may be corrupted or fraudulent and game play may be halted. It should be appreciated that the game controller 200 may perform other suitable security and authentication checks on the game data or software components. Such authentication and security devices and functions are unique to gaming and casino industry to minimize or prevent fraud in gaming devices and gaming systems.

For a player to interact with a gaming device, the game controller 200 receives and processes player inputs from, e.g., input device 115, and the game controller 200 causes processed results to be output or communicated to the player. In some implementations, player inputs are recognized and processed or directed for processing by input/output (I/O) controller 206. Further, I/O controller 206 may process and direct player outputs for communication to the player. The I/O controller 206 can function as the intermediary between the processor 202 and one or more input devices to control information and data flow therebetween. I/O controller 206 may also function as the intermediary between the processor 202 and one or more output devices to control information and data flow therebetween. I/O controller 206 is configured to understand the communication and operational details (such as hardware addresses) for the attached input devices and output devices. In this manner, processor 202 is freed from the operational details of the peripheral I/O devices. For example, in some implementations where an input or output device is changed or upgraded, the I/O controller 206 can be changed without changing other gaming system components.

In some implementations, a player deposits value into a gaming device by inserting some form of currency into a value acceptor 225 for game play. Alternatively, a player deposits value into a gaming device by inserting an encoded paper ticket into a value acceptor 225 for game play in some implementations. The value acceptor 225 can be combined with a currency reader and validator, and a code reader for reading value encoded on paper tickets. The value acceptor 225 may read, validate and communicate the amount of the inserted value to the processor 202. The processor 202 can establish a gaming credit balance for the player based on the communication from the value acceptor 225. Processor 202 can also communicate the player's credit balance on a credit balance display of gaming system 100. During game play, the processor 202 processes a player's wagers and determines the amount of credits to debit from the player's credit balance. When a winning outcome is obtained, the processor 202 is configured to determine the amount of credits to add to the player's credit balance.

As previously mentioned with respect to FIG. 1, a variety of value acceptance arrangements are possible. In some implementations, the value acceptor 225 could include magnetic strip or chip card readers to accept and transfer value. The value acceptor 225 may also be configured to accept and transfer non-traditional currencies such as digital currencies. In these implementations, I/O controller 206, a processor 202, or both contain appropriate control instructions to communicate and extract value from the inserted item containing value. In some implementations, use of a magnetic strip or embedded chip card, for example a bank card, for value insertion requires the processor 202 to communicate, via network interface 210 (described below), with devices external to a gaming device.

In some implementations, a card reader 227 may be included in gaming system 100 to accept player loyalty cards. For example, card reader 227 can extract account identifying information from the card and utilizes this information to access the associated account information stored remotely via network interface 210. In implementations where player loyalty/player tracking systems are employed, a player's loyalty account and record of gaming activity can be stored in a networked storage location or database. The processor 202 is configured to record the player's gaming activity in memory device 204 during the duration of loyalty card insertion. When the loyalty card is removed from card reader 227, recorded gaming activity is uploaded, via network interface 210, to the remote storage location associated with the player's account. In this manner, the player's gaming activity can be further processed and analyzed, and the player can be awarded loyalty rewards based upon his activity data.

In various implementations, an input device 115 receives a player's game inputs and communicates the player's game inputs to the processor 202. The player's game inputs may include, but are not limited to, wager amounts, pay line selections, game control signals, and cash-out signals. The input device 115 may generate signals based on button presses, touch screen activations, or voice control. The player-initiated signals are propagated to the processor 202 by the I/O controller 206. Further, the player-initiated signals may direct and inform execution of the game instructions stored in the memory device 204 and configured to be executed by the processor 202.

In some implementations, the processor 202 is configured to execute stored program code and instructions which generate random numbers or pseudo-random numbers. In some implementations, as illustrated in FIG. 2, a random number generator (RNG) 207 is a software module configured to be executed by the processor 202 for the generation of a true random or pseudo-random number. The code for RNG 207 may be stored in the memory device 204 or the storage system 212. The RNG 207 generates random numbers for use by the gaming software during game execution. In some implementations, random numbers are utilized by game software for the random selection of one or more game symbols from a set of game symbols during a game. As a non-limiting example, the set of game symbols can include numbers, letters, geometric figures, symbols, images, character, animations, blank symbols (e.g., the absence of symbols), or any other suitable graphical depiction. In various implementations, once random symbols are selected based upon the random number generated by the RNG 207, patterns of symbols are compared to determine wagering outcomes. In an alternative implementation, gaming system 100 may include a hardware based random number generator that is in communication with processor 202 to supply random numbers for game generation purposes. The hardware based random number generator may be incorporated into processor 202 or can be separate from processor 202.

In yet another implementation, the random generation of “numbers” or symbols may be performed with electro-mechanical components. For example, gaming devices such as gaming system 100 may incorporate mechanical game reels rotatable about a common axis. Indicia or symbols may be positioned around the periphery of the game reels. The indicia or symbols on the game reels may indicate separate detectable reel stop positions. The game reels can be set into a spinning/rotation motion by pulling a lever or pushing a button. In some implementations, the gaming system 100 can stop the game reels by a gaming device actuating, on a random timing basis, a suitable mechanical or electro-mechanical reel brake. When the game reels stop rotating, one or more displayed stop positions of the game reels are detected. Since the stop positions are associated with respective indicia or symbols, the gaming device can determine whether the combination of stop positions (i.e., translating to a combination of displayed symbols) results in a winning symbol combination.

Returning to FIG. 2, the game controller 200 controls the function and output of output devices utilized by a gaming device. In various implementations, I/O controller 206 serves as an interface unit between processor 202 and output devices, such as video processor 216, cabinet lighting controller 218, audio controller 220, and value dispenser 222.

In some implementations, the video processor 216 communicates with processor 202 to render all game graphics, video displays, and information on one or more video display units (e.g., displays 120, 130, and 134). In some implementations, the video processor 216 includes one or more processors, controllers, and/or graphics cards for processing the game images, outcomes, and animated displays and coordinating the processed data to be display between, among, or across any or all display devices. In various implementations, this may include being configured to simulate objects and the movement of objects which represent video game reels containing sets of gaming symbols.

It should be appreciated that in certain other implementations where physical mechanical game reels are utilized by the gaming system 100 as a game displays, reel controllers and stepper motors would be provided in lieu of or in addition to video processor 216.

In implementations which utilize cabinet lighting as described with respect to FIG. 1, a cabinet lighting controller 218 may be utilized to coordinate and control the color and timing of cabinet lighting displays with processor 202. In certain implementations which utilize sound design, processor 202 may utilize audio controller 220 to coordinate and control the sound emissions. In some implementations, audio controller 220 may include one or more audio processing cards for generating sound and for driving the one, two or more speakers 142 that may be included with a gaming device.

In various implementations, players may request the remaining credit value by making a request or initiating a signal via input device 115 which is communicated to processor 202 via I/O controller 206. The signal triggers a readout of the player's credit amount and processor 202 initiates a value dispensing signal which, in turn, is communicated to value dispenser 222. In some implementations, value dispenser 222 can be controlled to issue the player's credit value using any of the types of value discussed herein. In some implementations, the player's credit value may be issued to the player via a printed and dispensed encoded paper ticket or token which the player can then exchange at a special purpose kiosk or cashier location for the monetary value encoded into the ticket or token. In some implementations, the processor 202 can direct the value dispenser 222 to issue to the player an appropriate amount of coin or bills directly to the player. Additionally, or alternatively, in some implementations, the player may have the option to electronically direct the credit value to an account associated with the player.

In some implementations, the game controller 200 may communicate with one or more devices outside the gaming device. For example, gaming system 100 may be connected to a larger network 250 via a local area network (LAN) or a wide area network (WAN). The game controller 200 may communicate with one or more central servers, controllers, or remote devices to execute games, establish credit balances, participate in jackpots, etc. In such implementations, network communications and connections are accomplished via a network interface 210. Network interface 210 can be a digital circuit board or card installed in game controller 200 to provide network communications with external devices.

In some implementations, various additional features and functions are performed by the game controller 200. For example, the game controller 200 may be specially configured with software to track all game play events that occur on a gaming device. In some implementations, the game controller 200 may audit all recorded monetary transactions, including all wager amounts, game outcomes, game winnings, and game payouts that occur through the value dispenser 222. Further, some implementations may include security software to assist in protecting the gaming system 100 from tamper or alteration attempts.

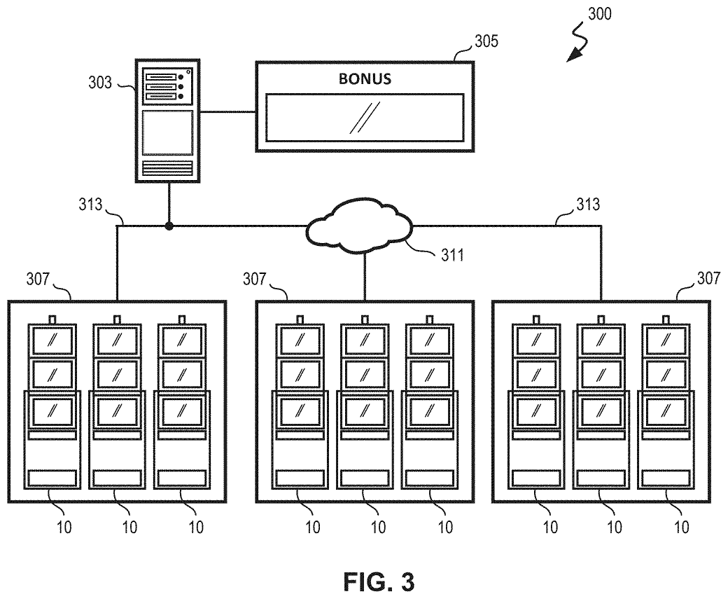

FIG. 3 illustrates an example of an environment 300 for implementing systems and method in accordance with an implementation of the present disclosure. The environment 300 includes a bonus server 303 and a bonus display 305 that are functionally connected with one or more banks 307 of one or more gaming systems 10 via a network 311 and one or more wired or wireless communication links 313. The bonus server 3033 can be one or more computing devices comprising hardware, software, or a combination thereof that manages bonus games provided by the gaming systems 10 of one or more of the banks 307. In implementations, the bonus server 303 functions to collect and maintain funds for one or more bonuses, display the values of the bonuses using the bonus display 305, and provide the bonuses to the gaming systems 10. For example, the bonus server 303 can maintain different pools of funds corresponding to different bonus levels (e.g., small, large, and grand/jackpot bonuses). In some implementations, the bonuses can be progressive bonuses in which the bonus server 303 incrementally accumulates the pools from wagers made at the gaming systems 10.

The bonus display 305 can include one or more display devices that display values of the bonuses managed by the bonus server 303. The bonus display 305 can be a video display or a mechanical display device. For example, the bonus display 305 can be a cathode ray tube (CRT) display, a liquid crystal display (LCD), a light-emitting diode (LED) display, a flip card display, a reel display, etc. The bonus display 305 may be located so as to be viewable by players of the gaming systems 10 in a same location or a same bank 307. In some implementations, the banks 307 of gaming systems 10 can be collocated within view of the bonus display 305. While FIG. 3 shows a single bonus display 305, it is understood that the environment 300 can include more than one bonus display 305. In some implementations, multiple bonus displays 3055 may be used, such as when some of the banks 307 are at different physical locations. In some implementations, the individual gaming systems 10 can include respective bonus displays 305. For example, the gaming systems 10 can include respective top displays (e.g., display 134 in FIG. 2) repeating the function and information provided by the bonus displays 305. All bonus displays connected to the network 311 may have substantially the same information displayed. For example, while individual banks 307 or gaming systems 10 may have different games or themes, such banks 307 and gaming systems 10 may participate in bonus games having a common bonus pool that is managed and paid out by the bonus server 303 based on the accumulation or combinations of persistent game indicators.

The banks 307 can include two or more gaming systems 10 that may be at the same or different locations as the bonus server 303 or one another. The locations can be different spaces within a single facility (e.g., casino, airport, or mall) or in spaces at separate locations.

The network 311 can be a wired or wireless computer network that functions to exchange information between the bonus server 303 and the gaming systems 10. The network 311 can be, for example, a peer-to-peer network, a local area network, a wide area network, or the Internet. The network 311 may be located in a single location or spread over multiple locations and may be connected to other networks.

The gaming systems 10 in the network 311 may include displays for a main game and a bonus game. The bonus game may be common to the gaming systems 10, while one or more of the gaming systems 10 may provide different base games. The bonus may be provided when certain criteria at one of the gaming systems 10 are achieved in the bonus game. The criteria may be, for example, the display of a particular symbol or symbol combination, or a particular outcome of the bonus game.

In some implementations, the gaming systems 10 may participate in multiple bonus games having respective bonus awards. For example, a first bonus may be available when the player makes a small wager, a second, larger bonus may be available when the player makes a larger wager, and a third, still larger bonus may be available when the player makes an even larger wager. It understood, however, that the different bonus levels available may not be associated with wagers of a player. Instead, for example, all of the different bonus levels may be available to the player and the award of a particular level may correspond to the outcome of the bonus game.

### Gaming System Operation

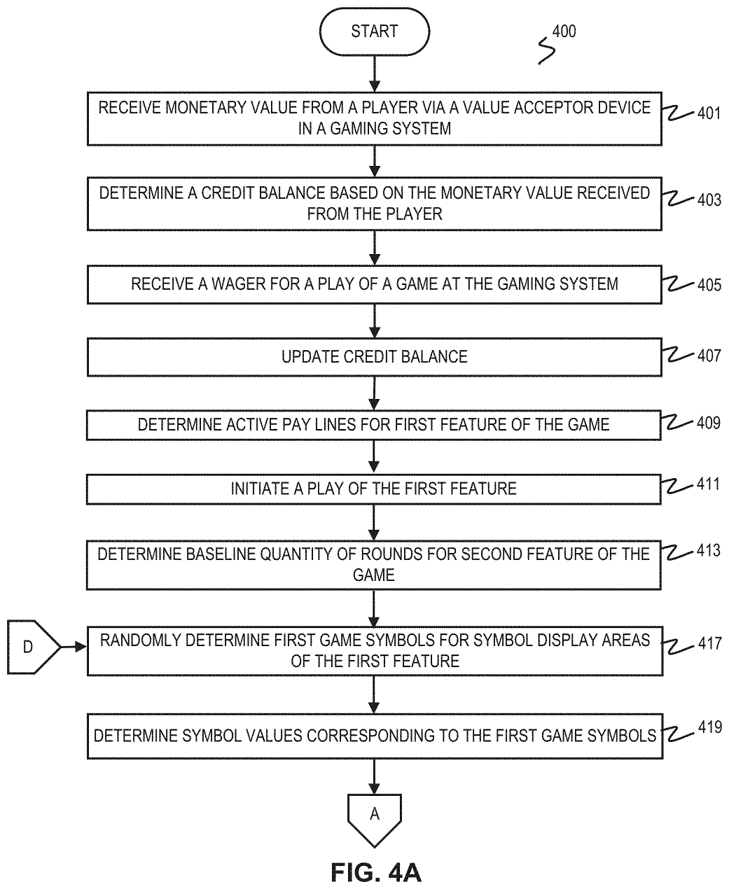

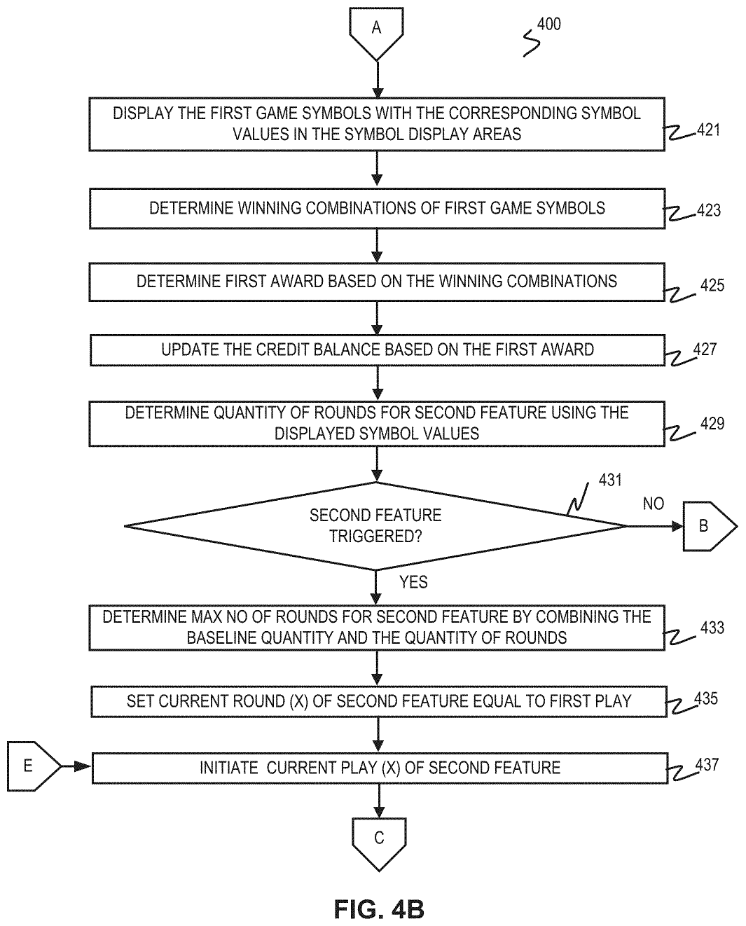

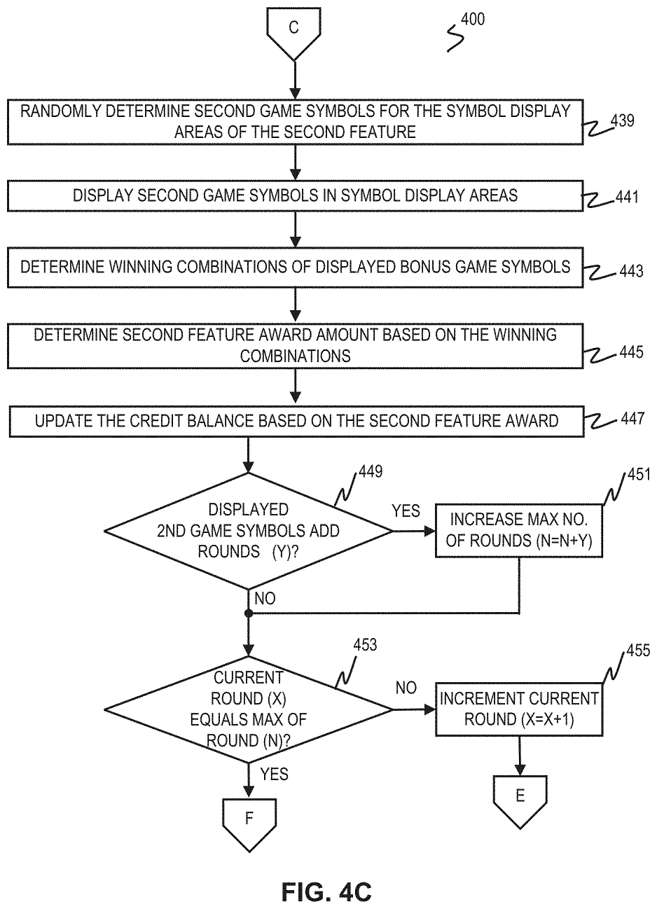

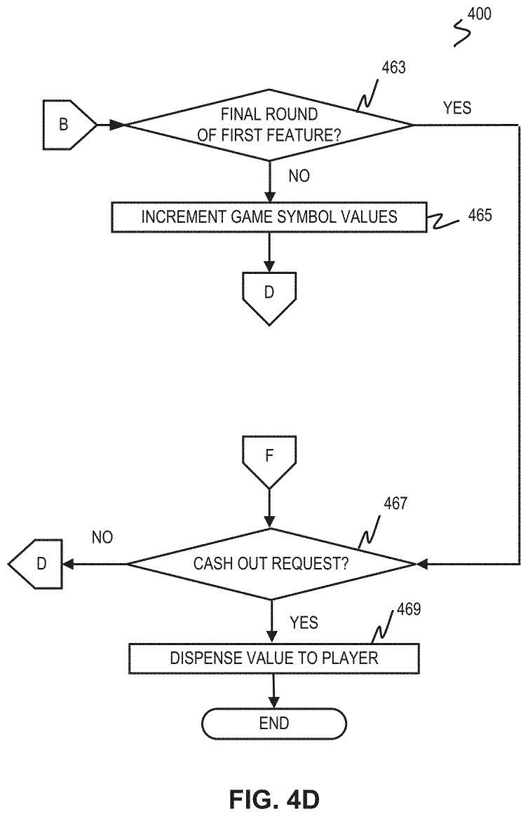

The flow diagrams in FIGS. 4A-4D illustrate functionality and operations of systems, devices, processes, and computer program products according to various implementations of the present disclosure. Each block in FIGS. 4A-4D can represent a module, segment, or portion of program instructions, which includes one or more computer executable instructions for implementing the illustrated functions and operations. In some implementations, the functions and/or operations illustrated in a particular block of the flow diagrams can occur out of the order shown in FIGS. 4A-4D. For example, two blocks shown in succession can be executed substantially concurrently, or the blocks can sometimes be executed in the reverse order, depending upon the functionality involved. Additionally, in some implementations, the blocks of the flow diagrams can be rearranged in different orders. Further, in some implementations, the flow diagram can include fewer blocks or additional blocks. It is also noted that each block of the flow diagrams and combinations of blocks in the flow diagrams can be implemented by special-purpose hardware-based systems that perform the specified functions or acts, or combinations of special-purpose hardware and computer instructions.

FIGS. 4A-4D show a process flowchart illustrating an example of a method 400 of operating a gaming system (e.g., gaming system 10) in accordance with aspects of the present disclosure. FIGS. 4A-4D describe parts of a multi-feature game, including a first feature and a second feature enabled by predetermined events in the first feature. In some implementations, the first feature is a base game and the second feature is a bonus game that may be triggered from the base game. However, it is understood that FIGS. 4A-4D may be integrated as a single game in which the elements of the second feature occur in every game. In some implementations, one or more processors (e.g., processor 202) of the gaming system are configured, via instructions (e.g., gaming module 205) stored in a memory device (e.g., memory device 204 or storage system 212) to perform the method 400.

In some implementations, a play of a game begins when the gaming system receives a monetary value from a player (e.g., block 401). In other implementations, a play of the game begins when the gaming system receives a wager (e.g. block 405). In some implementations, play of the game can start after block 425, without being triggering by any primary game or base game (e.g., a first feature). The play of the game can end when the first feature is complete and no second feature is triggered or otherwise initiated (e.g., block 433, “No”). The play of the game can also end when the gaming system receives a request to cash out (e.g., block 467, “Yes”). In some implementations, block 469 is not part of a play of a game. In alternative implementations, block 469 is part of a play of a game.

Turning to block 401 in FIG. 4A, the gaming system (e.g., gaming system 10) performing the method 400 receives a monetary value via a value acceptor device (e.g., value acceptor 225) in block 401. In block 403, the gaming system determines a credit balance based on the monetary value received in block 401. In block 405, the gaming system receives a wager for a play of a game from a player via an input device (e.g., input device 115) using, e.g., the credit balance determined at block 403. In some implementations, the gaming system allows the player to place a minimum wager, a maximum wager, or other wager therebetween. Also, in some implementations, an amount of the wager determines the value of some of the awards available from the game. In some implementations, the gaming system determines whether the credit balance determined at block 403 includes enough credits to enable the wager received at block 405. The gaming system may prevent the player from placing the wager and initiating play of a game if the credit balance determined at block 407 is not large enough to support the wager. If enough credits are not available in the player's credit balance, the gaming system may provide the player with an option to insert additional value to obtain the minimum credit level or to cash out of the gaming system.

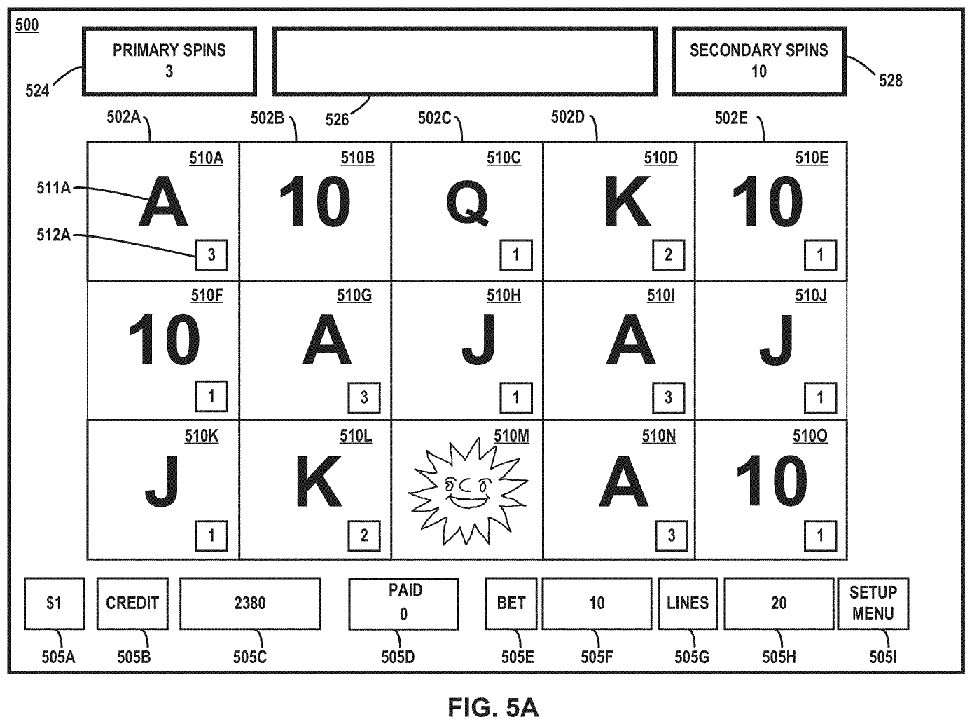

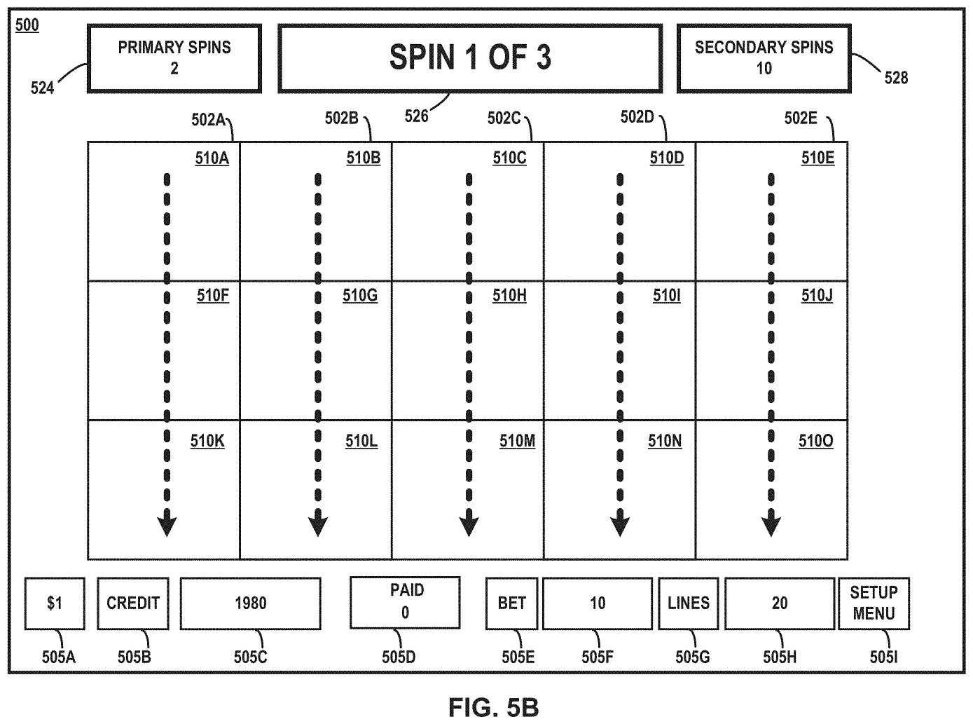

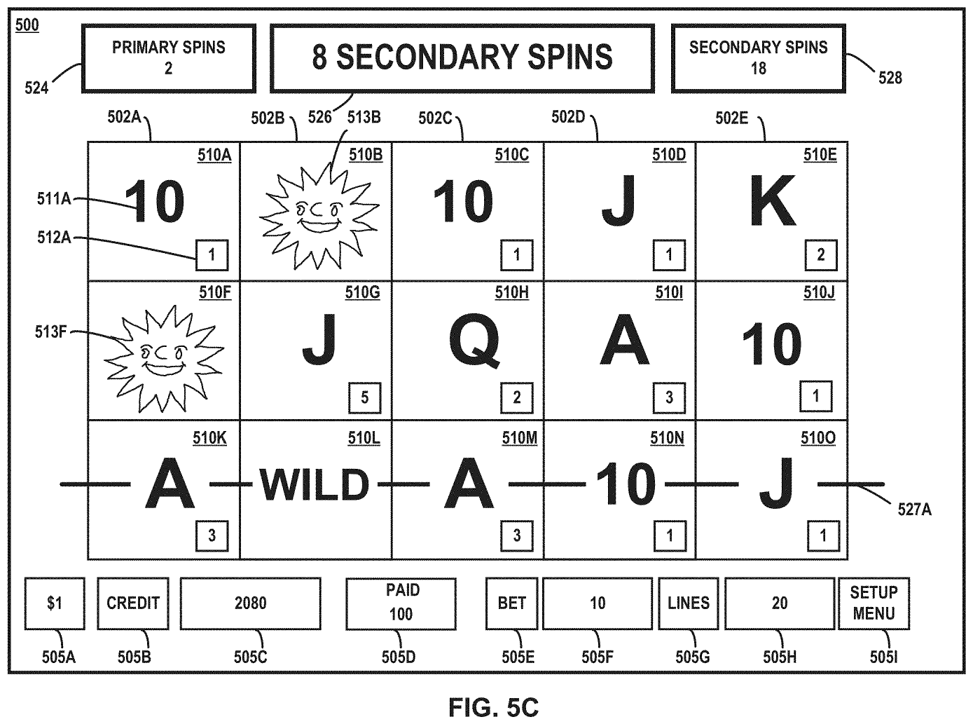

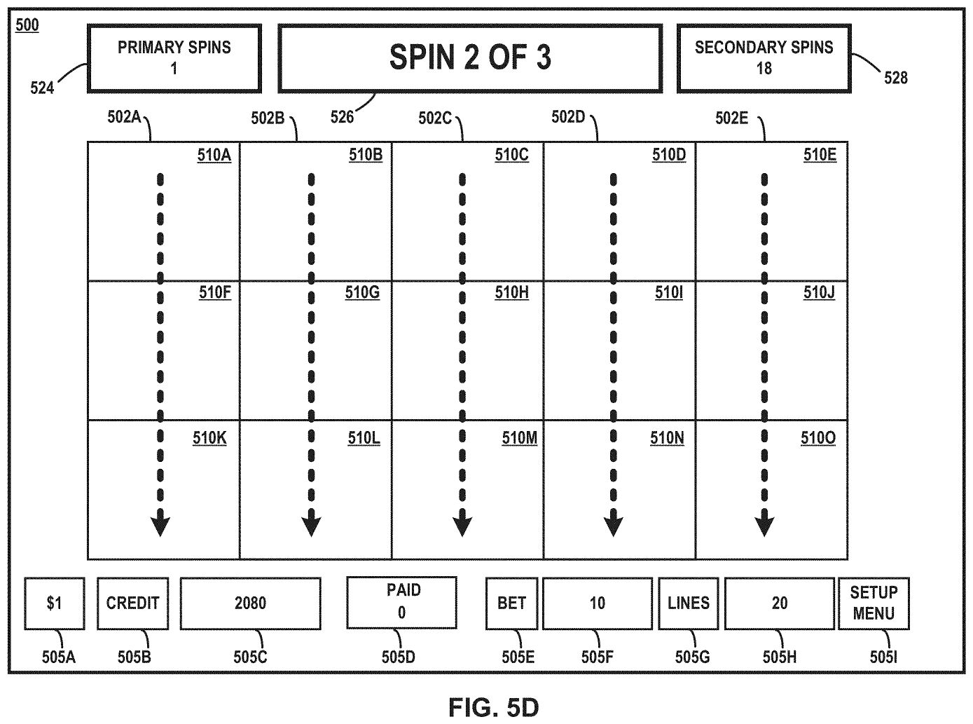

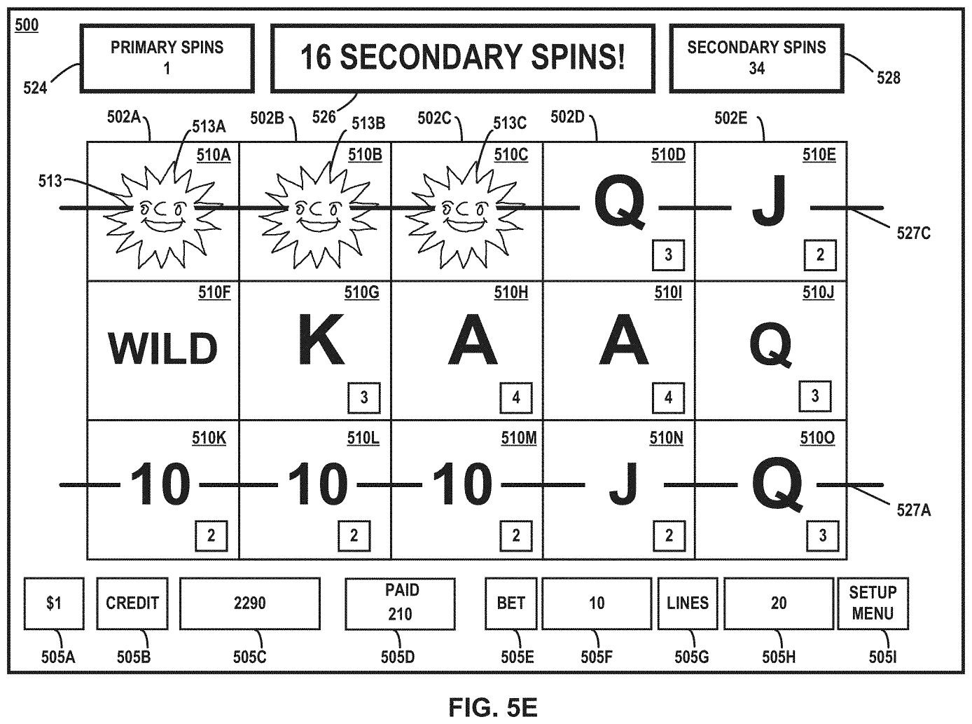

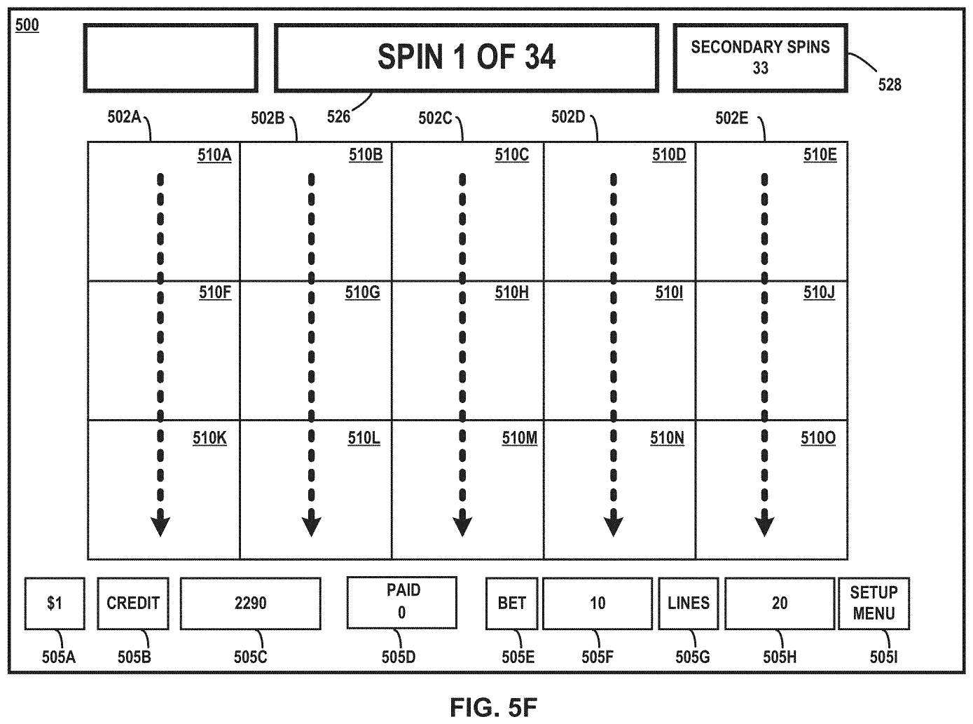

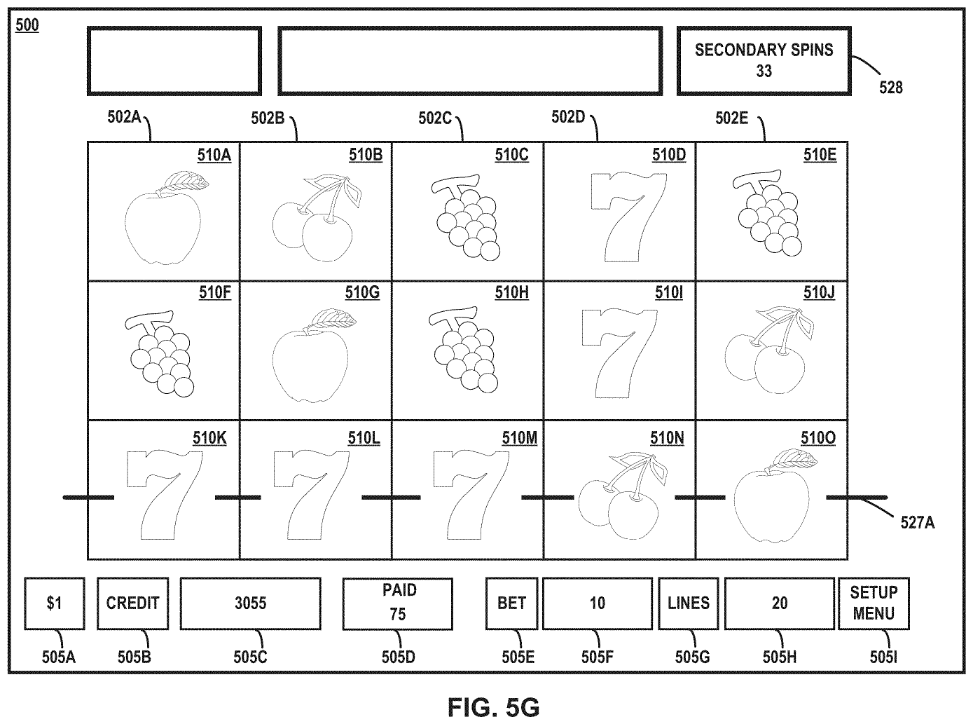

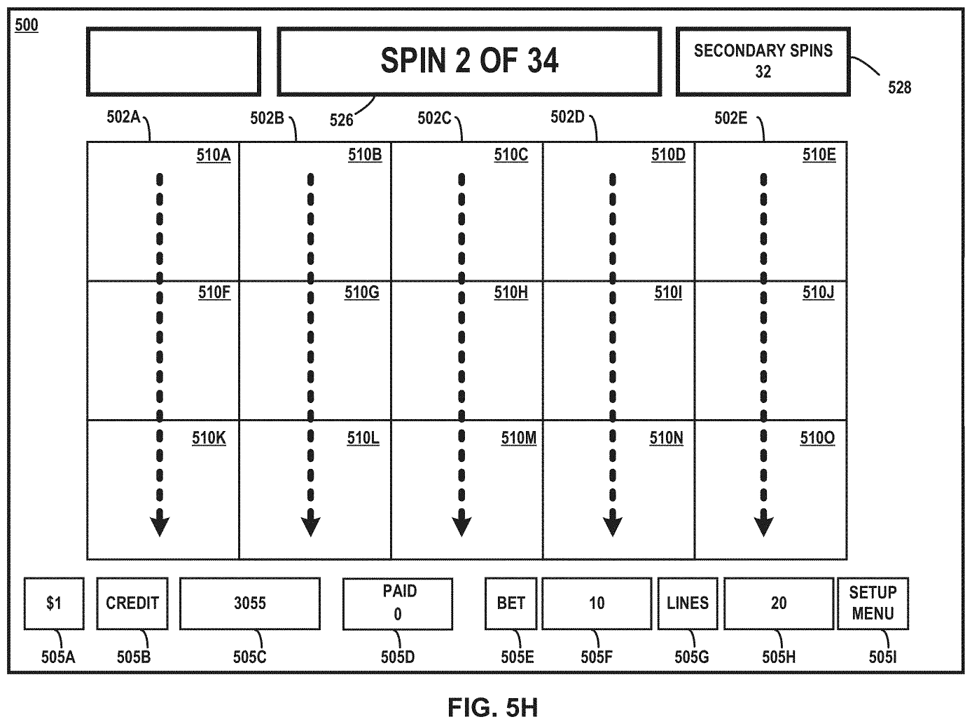

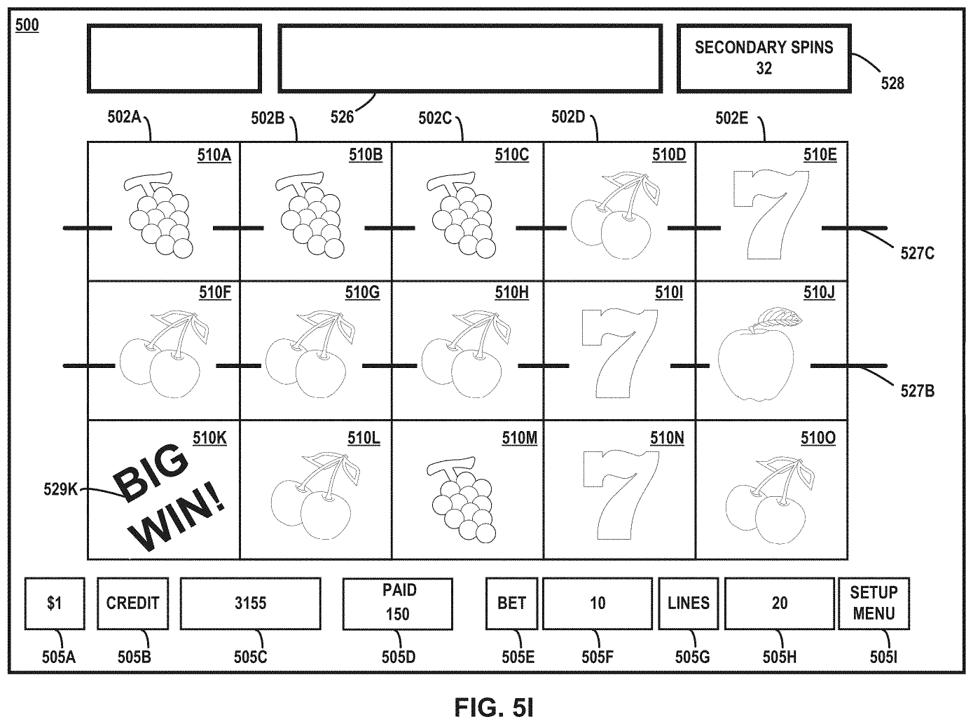

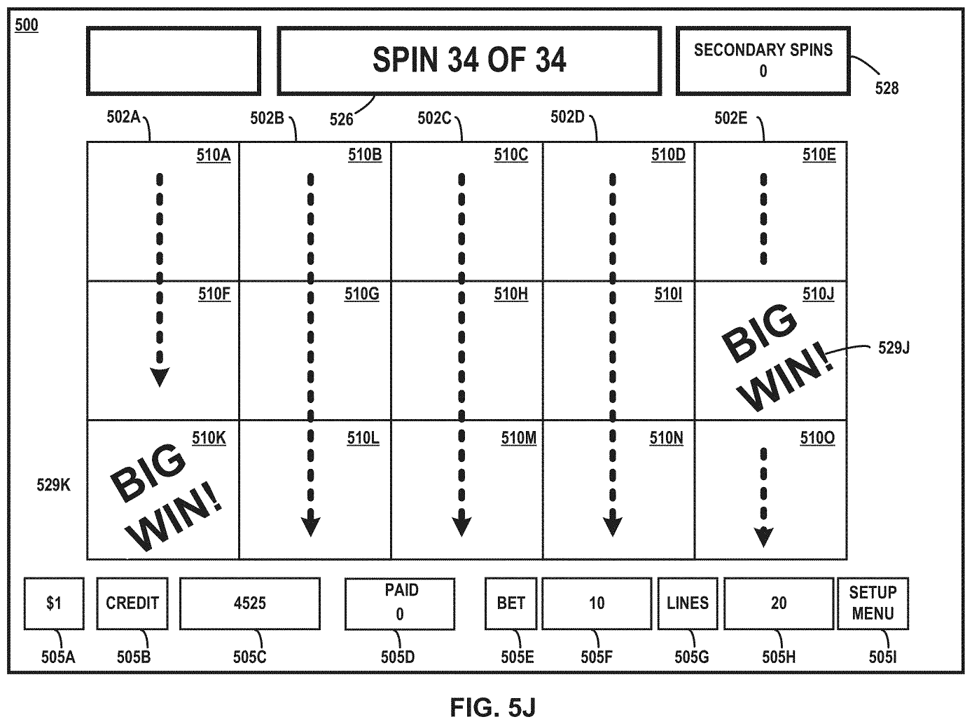

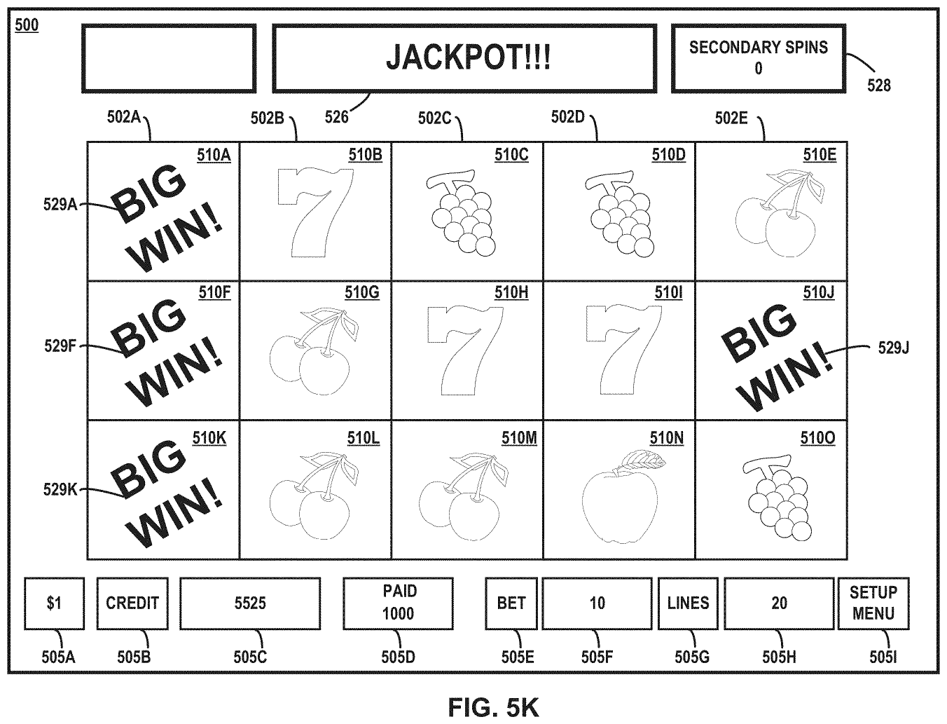

In some implementations, the wager received at block 405 funds a game session including more than one round of the first feature of the game (e.g., a base game). During the first feature, the player may trigger the second feature (e.g., a bonus game) and accumulate rounds (e.g., spins) for such second feature. For example, the wager received at block 405 may provide a player with three rounds of a first feature and, if triggered, ten rounds of the second feature (such as shown in the counters displayed by first round indicator area 524 and second round indicator area 528 of FIG. 5A, which illustrates a screen shot of a game screen 500 prior after initiation of the first game feature, but prior to a first spin of the game reels 502A-502E). The first feature may award additional rounds of the second feature that are combined with the initial ten rounds. At block 407, the gaming system updates the credit balance determined at block 403. In some implementations, the credit balance is updated based on the amount of the wager received at block 405. It is understood that some implementations of the method 400 may not include block 407 and that the gaming system may update player's credit balance at other times (e.g., at block 461), such as at the completion of the game.

At block 409, the gaming system determines active pay lines (a.k.a., wagered pay lines) for the first feature. In some implementations, depending on the amount of the wager received at block 405, the gaming system enables the player to select particular pay lines across reel symbol positions displayed in a game screen (e.g., symbol display areas 410 on game reels 402 of game screen 500 in FIGS. 5A-5I). Although in some implementations, the gaming system selects the active pay lines automatically based on the wager received at block 405. It is understood that some implementations of the gaming system may not include pay lines and, as such, the method 400 may not perform block 409. For example, the gaming system may use ways-pays (e.g., all-ways pays) as an alternative to pay lines. It is further understood that some implementations may use ways-pays as an alternative or in combination with the active pay lines determined at block 409.

At block 411, the gaming system initiates a play of the first feature of the game. The initiation can be automatically triggered in response to the wager at block 405 or it can be manually triggered in response to receiving an input via an input device. For example, the player may press a spin button on the gaming system (e.g., input device 115) to start spinning the game reels (e.g., reels 502A-502E in FIG. 5A) of the gaming system (or randomly generating symbols using other methods) for the play of the game. In some implementations, the first feature includes multiple rounds that are iteratively repeated until all of the rounds are completed or until the second feature is triggered. In some implementations, the quantity of rounds of the first feature is a predetermined, fixed quantity (e.g., 3 rounds, or some other suitable quantity). In some implementations, the quantity of rounds of the first feature corresponds to an amount of a wager received at block 405. For example, a larger wager may grant a greater quantity of rounds. In some implementations, the gaming system may randomly determine the maximum quantity of rounds in the first feature. Also, in some implementations, initiating the play of the first game includes resetting the value of counters (e.g., the values of first round indicator area 524 and second round indicator area 528 shown in FIGS. 5A-5C).

At block 413, the gaming system determines a baseline quantity of rounds for the second feature of the game (e.g., 1 spin, 10 spins, or some other suitable quantity). In some implementations, the quantity of rounds for the second feature of the game is a fixed quantity. For example, triggering the second feature trigger may always provide a predetermined quantity of rounds for the second feature (e.g., 10). In other implementations, the quantity of rounds for the second feature varies. For example, different triggers (e.g., symbols or combinations of symbols) in the primary feature may provide different quantities of the rounds in the second feature. Additionally or alternatively, in some implementations the quantity of rounds of the second feature correspond to an amount of a wager received at block 405. For example, a larger wager may grant a greater quantity of rounds in the second feature (e.g., a player can increase the wager to incrementally increase the number of rounds). In some implementations, the maximum quantity of rounds is determined based on an amount of an additional wager receive from the player at block 427 (e.g., an additional bet input using button 505E.) In some implementations, the baseline quantity of rounds is determined randomly from a predetermined range (e.g., 1-10) using a random number generator. In some implementations, the gaming system may randomly determine the maximum quantity of rounds in the second feature based on the wager (e.g., one credit provides one round).

At block 417, the gaming system randomly determines, using a random number generator (e.g., random number generator 207), first game symbols (e.g., game symbol 511A in FIG. 5A) for the first feature from one or more sets of symbols. In implementations in which the game reels are rendered using a video display (e.g., display 120), the random number generator can be used to select the first game symbols from the one or more sets of game symbols (e.g., game symbols 214). As non-limiting examples, the sets of first game symbols can include graphical indicators depicting numbers, letters, geometric figures, playing cards, images, characters, animations, blanks (e.g., the absence of symbols), or the like. Additionally, the sets of first game symbols may include modifier symbols, such as cash award symbols (e.g., 100 credits or $10) and award multiplier symbols (e.g., a 10× increase in an award of a winning combination). Further, the sets of first game symbols may include special or designated symbols (e.g., wild symbols, trigger symbols, scatter symbols, collectible symbols, free game symbols, etc.). In some implementations, types of game symbols included in the sets may be different. A first set may include poker symbols, a second set may include “wild” symbols (e.g., Joker symbols), a third set may include trigger symbols that can trigger the second feature or a bonus feature, a fourth set may include free round symbols for the second feature. While the game reels above are described as being rendered by a video display, it is understood that some implementations may instead use electro-mechanical game reels where, using the random number generator, the gaming system controls mechanical game reels to select symbols by physically rotating to a randomly-selected stop position.

At block 419, the gaming system determines symbol values (e.g., symbol value 512A in FIG. 5A) for some or all of the first game symbols determined at block 417. The symbol values may be fixed or they may vary. For example, in some implementations, the symbol values may be predetermined. In other implementations, the symbol values may vary based on the wager received at block 405. For example, larger wagers may correspond to larger symbol values or larger ranges of symbol values. In other implementations, the gaming system randomly determines the symbol values. Also, certain types of the first game symbols (e.g., poker symbols, fruit symbols, letter symbols, etc.) may have symbol values, whereas certain other types of the first game symbols (e.g., special or designated symbols) may lack symbol values. In some implementations, the symbol values may be different for different symbols. For example, in some implementations, the symbol values (e.g., 5, 4, 3, 2, and 1) may have predetermined, fixed values corresponding to the respective values of the first game symbols (e.g., Ace, King, Queen, Jack, and Ten). In some implementations, the symbol values may have fixed values that are independent of the relative value of the first game symbols. In some implementations, the symbol values may be randomly determined independent of the relative value of the first game symbols.

Turning to FIG. 4B, as indicated by off-page connector “A,” at block 421, the gaming system causes the display device (e.g., display 120) to display the first game symbols determined at block 417. In implementations, the game system also displays the symbol values, as determined at block 419, corresponding to the first game symbols. For example, in some implementations in which the game reels are rendered using a video display, the gaming system may populate all visible symbol display areas (e.g., symbol display areas 510A-51O in FIG. 5A) displayed by the one or more game reels (e.g., game reels 502) displayed in the game screen.

At block 423, the gaming system determines winning symbol combinations of the first game symbols displayed in the symbol display areas at block 421, if any. At block 425, the gaming system determines a first feature award based on the winning combinations determined at block 423, as well as any additional award associated with game symbols displayed in the active pay lines, if any. In some implementations, the gaming system evaluates the first game symbols displayed across active or wagered pay lines determined at block 409 for winning combinations at block 423, while not evaluating game symbols outside the active pay lines. For example, a pay table (e.g., pay table 215) associated with the gaming system may indicate that a sequence of at least three of the same first game symbols (when evaluated left-to-right, right-to-left, and/or scattered) is a winning combination and award a predetermined award corresponding to such winning combination. Accordingly, the gaming system would evaluate the first game symbols for such sequence of symbols (e.g., three Ace (“A”) symbols). If the gaming system generated at least three game symbols in a sequence along an active pay line on adjacent symbol display areas of the game reels, the gaming system may determine that the three first game symbols are a winning symbol combination based on the predetermined pay table. While the present example describes a sequence of three game symbols, it is understood that the pay table may prescribe correspondences between various winning symbol combinations and awards. In some implementations, the pay table may indicate that as few as one game symbol may be associated with an award. Alternatively, two or more game symbols may be used to form winning symbol combinations that result in an award.

At block 427, the gaming system updates the credit balance determined at block 407 based on the amount of the award determined at block 425. It is understood that some implementations of the method 400 may not include block 427 and that the gaming system may update player's credit balance at other times (e.g., at block 447), such as at the completion of the game.

At block 429, the gaming system determines a quantity of rounds for the second feature of the game based on symbol values determined at block 419 corresponding to the first game symbols displayed at block 421. In some implementations, the gaming system combines all of the symbol values of the displayed game symbols. In other implementations, the gaming system only combines the symbol values of the first game symbols included in the active pay lines determined at block 409 that include winning combinations of the first game symbols determined at block 423. In other implementations, the gaming system only combines the symbol values of first game symbols included in the winning combinations and in the active pay lines. In other implementations, the gaming system only combines the symbol values of displayed game symbols included in winning combinations and in active pay lines.

At block 431, the gaming system determines whether to trigger the second feature. In some implementations, the gaming system triggers the second feature based on, for example, an output from a bonus controller (e.g., bonus server 303). In some implementations, the gaming system randomly triggers the second feature based on, for example, an output from the random number generator. In some implementations, the gaming system randomly triggers the second feature after occurrence of a threshold number of events since trigging a previous second feature (e.g., after a number of wagers in a session, after a number of game iterations in the session, or after a predetermined period of time). In some of such implementations, the gaming system triggers the second feature based on determining that the first game symbols displayed at 421 include a trigger symbol, a number of trigger symbols, or a particular sequence of trigger symbols. For example, the gaming system may trigger the second feature if a sequence of three trigger symbols are displayed in an active pay line (e.g., trigger symbols 513A, 513B and 513C in pay line 527C in FIG. 5E).

If the gaming system determines that the second feature has not been triggered (e.g., block 431 is “No”), then the method 400 proceeds to block 463 of FIG. 4D, as indicated by off-page connector “B.” At block 463, the gaming device determines whether the current round of the first feature is the final round of the first feature. For example, where the wager received at block 405 provides three rounds for the first feature, the gaming system may determine whether the current round of the first feature is the third round. If the current round is the final round of the first feature (e.g., block 463 is “Yes”), then the method can proceed to block 467 in FIG. 4D, as detailed below. On the other hand, if the current round is not the final round of the first feature (e.g., block 463 is “No,” as illustrated in FIG. 5C showing “2” spins remaining in first round indicator area 524), then the method can proceed to block 465.

At block 465, the gaming system increments the symbol values corresponding to the game symbols for the sets of symbols used for the second feature. For example, in the first round of the first feature in a gaming session, a symbol value corresponding to a particular game symbol may have an initial value of “1,” for a second round of the first feature, the gaming system may incrementally increase the symbol value associated that same game symbol to “2,” for a third play of the first feature, the gaming system may incrementally increase the symbol value associated that same game symbol to “3,” and so on. In some implementations, the symbol values may for some or all of the game symbols may be capped to a maximum value, such as “5.” Such cap may be different for different game symbols. It is understood that other values and increments for the symbol values may be used and that such values and increments may be different for different game symbols. For example, a game symbol having a corresponding symbol value of “8” could increase by increments of one-quarter of its symbol value (e.g., 2). After completing a round of the first feature at block 465 that is not a maximum round (e.g., a final round as determined at block 463), the method 400 iteratively performs another round of the first feature by returning to block 417 in FIG. 4A, as indicated by off-page connector “D.” In some implementations, the method 400 may iteratively return to block 405 of FIG. 4A, instead, of block 417, such that gaming device receives another wager for an additional round of the first feature.

Referring back to block 431, if the gaming system determines the second feature has been triggered (e.g., block 431 is “Yes,”) then at block 433, the gaming system determines a maximum quantity of rounds for the second feature by combining the quantity determined at block 429 with the baseline quantity determined at block 413. For example, the gaming system may add determined quantity and the baseline quantity. It is understood that other methods of combining the quantities can be used (e.g., multiplication, factoring, concatenating, or other suitable method of combining values). In some implementations, the gaming system displays the maximum quantity of rounds determined at block 433 (such as the counter shown in second round indicator area 528 of FIG. 5C).

At block 435, the gaming system can set a current round (X) (e.g., as illustrated by round information area 526 in FIG. 5F) to a first round (X=1) of the maximum quantity (N) of rounds determined at block 433. At block 437, the gaming system can initiate the current round of the second feature. The initiation can be automatically triggered in response to the triggering of the second feature at block 425 or it can be manually triggered in response to receiving an input via an input device. For example, the player may press a spin button on the gaming system (e.g., input device 115) to start spinning the game reels (e.g., game reels 502 in FIG. 5A) of the gaming system (or randomly generating symbols using other methods) for the round of the second feature.

Turning to FIG. 4C, as indicated by off-page connector “C,” at block 439, the gaming system randomly determines (e.g., using the random number generator 207) second game symbols for the symbol display areas (e.g., symbol display areas 510A-510O of the game screen 500) using one or more symbol sets (e.g., game symbols 214). The determination of the second game symbols can be performed in a same or similar manner to that previously described above with regard to block 417. In some implementations, the game symbols included in the symbol sets can be the same or similar to those describe previously herein. The second game symbols in the symbol sets used at block 433 can be different than the first game symbols used at block 417. For example, the second game symbols can include different types and combinations than the symbols sets used at block 413. Additionally, the second game symbol can include symbols (e.g., special symbols or designated symbols) that, alone or in combination, provide additional rounds for the second feature (e.g. free spins in addition to the initially provided quantity of frees spins).

At block 441, the gaming system causes the display device (e.g., display 120) to display the second game symbols determined at block 439 in the symbol display areas in a same or similar manner to that described above with regard to block 421. In some implementations, one or more of the symbols in the sets of second game symbol may be persistent game indicators or symbols. Differently from other game symbols, in implementations, the persistent game symbols or indicators are held locked in their respective symbol display areas from round-to-round during the second feature.

At block 443, the gaming system determines winning symbol combinations of the second game symbols displayed in the symbol display areas at block 441 in a same or similar manner to that previously described at block 423. The winning symbol combinations may be determined using a pay table (e.g., pay tables 215), which can be the same or different than the pay table used at block 417. At block 445, the gaming system determines a second feature award amount based on the winning combinations of second game symbols determined at block 443, if any, as well as any additional award symbols that may be displayed in the active pay lines. At block 447, the gaming system updates the credit balance determined at block 421 based on the bonus round award determined at block 445. It is understood that some implementations of the method 400 may not include block 447 and that the gaming system may update player's credit balance at other times (e.g., at block 467), such as at the completion of the game.

At block 449, the gaming system determines whether the second game symbols displayed at 435 provide additional rounds (Y) for the second feature. For example, the gaming system may determine that one of the symbol display area displayed a bonus symbol corresponding to an award of three additional free rounds for the second feature (e.g., “3 Free Spins”). If so (e.g., block 449 is “Yes”), then at block 451, the gaming system can increase the maximum quantity of rounds (e.g., N=N+Y). For example, if at block 433 the gaming system determined that the maximum quantity of free spins for the second feature was twenty (e.g., N=20), and if at block 449 the gaming system determined that the displayed bonus symbol provided three additional spins (e.g., Y=3), then at block 451, the game device increases the maximum quantity of spins to twenty-three (e.g., N=20+3=23). The method 400 would then proceed to block 453. If at block 449, the gaming system determined that the game symbols did not provide additional rounds (e.g., block 449 is “No”), then the method 400 proceeds to block 453 without modifying the maximum quantity of rounds determined at block 433.

At block 453, the gaming system determines whether the current round (X) of the second features is equal to the maximum quantity of rounds (N) determined at block 433 or at block 451. In other words, the gaming system determines whether the current round is the final round the second feature. If the current round is not equal to the maximum quantity of rounds (e.g., block 453 is “No”), then the method 400 proceeds to block 455, at which the gaming system increments the value of the current round. For example, at block 453, if the current spin is the first spin (e.g., X=1) and the maximum spins is ten (N=10), then the current spin is not the last spin and the second feature. As such, at block 455, the gaming system would increment the current spin (X=1+1=2) and proceed to block 433 to initiate the current spin (X=2) of the second feature.

If, at block 453, the gaming system determines that the current round is equal to the maximum round (e.g., block 453 is “Yes”), then at block 467 of FIG. 4D, as indicated by off-page connector “F,” the gaming system determines whether it received a request to end game play or “cash out” via an input device (e.g., input device 115) of the gaming system. In such event (e.g., block 463 is “Yes”), then at block 469, the gaming system dispenses a value to the player, through a value dispenser (e.g., value dispenser 222) based on the player's gaming credit balance and the method 400 ends. On the other hand, at block 467, if the gaming system has not received a request to end game play or cash out (e.g., block 467 is “No”), the method 400 returns to block 405 in FIG. 4A, as indicated by off-page connector “D”.

FIGS. 5A-5K show example images of a game screen 500 displayed by a gaming system (e.g., gaming system 10) in accordance with aspects of the present disclosure. More specifically, FIGS. 5A-5I illustrate examples of screen shots the game screen 500 that may be displayed by a display device (e.g., display device 120) by one implementation of the gaming system. As detailed previously herein, implementations consistent with the present disclosure can provide a game including a multi-round first feature (e.g., a base game) and a multi-round second feature (e.g., a bonus game). FIGS. 5A-5E illustrate examples of the game screen 500 that may be generated during the first feature and FIGS. 5G-5K illustrate examples of the game screen 500 that may be generated during the second feature.

In an example of the first feature, the game screen 500 can include game reels 502A-502E. In implementations, the game reels 502A-502E comprise a set of virtual video game reels arranged substantially side by side so as to form a rectangular array. The game reels 502A-502E include symbol display areas 510A-510O (a.k.a., symbol display positions). As illustrated in FIG. 5A, the symbol display areas 510A-510O are arranged so as to provide the appearance of a set of five game reels so as to represent a slot machine. In some implementations, such as illustrated in FIG. 5A, the five game reels may be arranged so as to visibly show three symbol display positions on each of the five game reels 502A-502E. For example, the symbol display areas 510A-510O are each associated with positions on the reels 502A-502E, respectively. Particularly, in the example illustrated in FIG. 5A, the symbol display areas 510A, 510F, and 510K are associated with game reel 502A; symbol display areas 510B, 510G, and 510L are associated with game reel 502B; symbol display areas 510C, 510H, and 510M are associated with game reel 502C; symbol display areas 510D, 5101, and 510N are associated with game reel 502D; and symbol display areas 510E, 510J, and 5100 are associated with game reel 502E. When viewed together, reels 502A-502E appear like a 3-row by 5-column reel array (i.e., matrix) in game screen 500. In other implementations, smaller (e.g., 3×3) or larger (e.g., 4×5 or 5×5) visible arrays of the symbol display areas can be displayed.

It should be appreciated that the game reels 502A-502E can be displayed with different amounts of separation or no separation. For example, while FIGS. 5A-5K show the game screen 500 as including gridlines delineating the symbol display areas 510A-510O for the sake of clarity, it is understood that implementations of the game screen 500 may not include some or all of the gridlines. For instance, the game screen may include vertical gridlines or the like delineating the game reels 502A-502E, but lack horizontal gridlines delineating the respective symbol display areas 510A-510O of the game reels 502A-502E. Further, it is understood that the symbol display areas 510A-510O may have various sizes and proportions with respect to one another.

The reels 502A-502E may display game symbols (e.g., symbols, such as 10, Jack (“J”, Queen (“Q”), King (“K”), and Ace (“A”)) in their respective symbol display areas 510A-51OE that have been determined by the gaming system (such as previously described with regard to block 417 in FIG. 4A). As previously described herein, some or all of the game symbols may have corresponding symbol values. For example, symbol display area 510A includes a game symbol 511A (e.g., “A”) having a symbol value 512A (e.g., “3”). In some implementations, the reels 502A-502E are associated with respective sets of game symbols (e.g., game symbols 214), where each set of symbols includes a number of game symbols (e.g., a pool of game symbols). The sets of symbols can include the same or different game symbols, and such game symbols may be selectable at different frequencies. As previously described herein, the game symbols can include graphic indicators, pay symbols, modifier symbols, special symbols or designated symbols.

In addition to the game reels 502A-502E, the game screen 500 can also include several information areas and buttons 505A-505I. These information areas and buttons 505A-505I are illustrated in a particular arrangement, but may be arranged in any suitable manner in different implementations. In some implementations, game screen 500 may include more or fewer display areas and buttons 505A-505I than illustrated.

Information area 505A illustrates an example value of one credit (e.g., $0.01) for the game displayed in game screen 500. Information areas 505B and 505C illustrate an example of the amount of the player's available credits. For example, the value displayed in information area 505C (“2380”) may represent credit balance determined based on a monetary value received from a player via a value acceptor device (such as previously described with regard to blocks 401 and 403 of FIG. 4A). Information area 505D illustrates the amount of credits a player has won (such as previously described with regard to block 419 in FIG. 4B). Notably, because FIG. 5A illustrates the start of a play of a game, the information area 505D shows zero credits have been won.

Button 505E illustrates a software button that the player can select to place a wager (e.g., a bet, such as previously described with regard to block 405 in FIG. 4A). It should be appreciated that the functionality of button 505E may also be replicated or replaced with a hardware button on the gaming system 10. Information area 505F illustrates an amount of the wager made at information area 505E. For example, as illustrated in FIG. 5A, information area 505F indicates the player has selected to wager 10 credits.

Button 505G illustrates a software button that the player can select to determine how many pay lines to wager on (such as previously described with regard to block 409 in FIG. 4A). It should be appreciated that the functionality of button 505G may also be replicated or replaced with a hardware button on the gaming system 10. Information area 505H illustrates a number of pay lines selected by the player using button 505G. For example, as illustrated in FIG. 5A, information area 505F indicates the player selected to wager on 10 pay lines. Button 505I illustrates a software button that the player can select to obtain information about the game, change certain aspects of the game, obtain help, place an order, etc.

The gaming screen can also include a first round indicator area 524, a round information area 526, and a second round indicator area 528, which provide information about the state of the multi-round game. The first round indicator area 524 can indicate a number of rounds available to the player in the first feature of the game. For example, as shown in FIG. 5A, the first round indicator area 524 can indicate an initial value at the start of a first feature of the game (e.g., “Primary Spins 3”). The first round indicator area 524 may display the current quantity of rounds of the first feature available to the player. For example, if the gaming system provided the player with three rounds of the first feature, the first round indicator area 524 may initially indicate “3,” such as illustrated in FIG. 5A. After the player initiates a first round of the first feature, the gaming system can decrement the quantity of rounds of the first feature from “3” to “2,” as illustrated in FIG. 5B. The round information area 526 can indicate various information describing the current round of the game. For example, the round information area can indicate the current round (e.g., “Spin 1 of 3”) and round awards (e.g., “3 Second Game Spins”). The second round indicator area 528 can indicate a number of rounds available to the player in the second feature of the game in a same or similar manner to that of the first round indicator area 524. For example, as shown in FIG. 5A, the second round indicator area 528 can indicate an initial value at the start of a game (e.g., “Secondary Spins 10”). As illustrated in FIGS. 5A-5E, the initial value of the second round indicator area 528 can change during the first feature based on symbol values determined during the first feature (e.g., as previously described with regard to block 429 in FIG. 4B).

To start a gaming session using the gaming system, a player provides the gaming system with a deposit of value, using one of the mechanisms discussed above (such as previously described with regard to block 401 in FIG. 4A). The gaming system can validate the deposit of value received from the player. The gaming system can then issue credits (or gaming credits) to the player based on the received value (such as previously described with regard to block 403 in FIG. 4A). The credits enable the player to place wagers on the play of the game and initiate a play of a game (such as previously described with regard to blocks 405-411 in FIG. 4A). The gaming system may provide a visual indication of the credit balance to the player in information area 505C, as discussed above.

To initiate the play of the game during the gaming session, the player can activate or press one or more appropriate buttons on the gaming system (e.g., button 505E) to deduct credits necessary to play the game and to identify the wager received from the player (such as previously described with regard to block 405 in FIG. 4A). The gaming system may deduct the appropriate credits from the player's credit balance after the wager or at any suitable time (such as previously described with regard to block 407 in FIG. 4A). In some implementations, the gaming system may also update the player's credit meter (information area 505C) to reflect the player's available credit balance. As an example, FIG. 5B shows the player's credit meter (information area 505C) decremented by 200 credits from 2180 to 1980 to reflect the 10 credit wager the player placed on each of 20 pay lines for the play of the game. Along with receiving the player's wager, the gaming system may receive pay line selections (e.g., using button 505G) or other game functions the player wishes to activate in exchange for the wager (such as previously described with regard to block 409 in FIG. 4A). In some implementations, the gaming system automatically selects the pay lines for the player. The player may also actuate a game start button, a spin button, or a lever to initiate a play of a game (e.g., input device 115, such as previously described with regard to block 411 in FIG. 4A).

Additionally, as illustrated in FIG. 5A, the gaming system may indicate an initial number of rounds for the first feature of the game in first round indicator area 524 (e.g., “Primary Spins 3”). Also, the gaming system may indicate an initial number of rounds for the second feature of the game in second round indicator area 528 (e.g., “Secondary Spins 10”). As discussed above, the initial number of rounds in the first feature and the second feature may depend on the wager received from the player. In some implementations, the initial value of the rounds for the second feature is zero.

After initiating play of the first feature (e.g., as shown in FIG. 5A) and prior to displaying the symbols for such feature in the symbol display areas 510A-510O (e.g., at block 415 in FIG. 4A), the gaming system may cause the game screen 500 to display the game reels 502A-502E spinning (e.g., as shown in FIG. 5B), for example, to simulate the movement of mechanical game reels. Indicative of the first spin of three initially provided for the first feature of the game, the gaming system may decrement the first round indicator area 524. For example, the gaming system may decrement the first round indicator area 524 from “3” to “2,” the round information area 526 may indicate information regarding the current round (e.g., “Spin 1 of 3”) and, as represented by the dashed lines in FIG. 5B, show a display of spinning reels for each of the reels 502A-502E. The spinning may appear to occur in a vertical top to bottom direction or in a vertical bottom to top direction (not shown), or in a combination of vertical directions (not shown). It is understood that other displays can be used that do not simulate game reels of a slot machine. For example, the gaming system can display the game reels spinning in more than one direction, or the gaming system may not provide any display depicting the reels spinning. It is also understood that games other than a spinning reel slot machine may be provided using the game reels 502. For example, in some implementations, the gaming system may display symbols in the symbol display areas 510A-510O in the reels 502 randomly changing or changing in some pattern. Also, while the symbol display areas 510A-510O are illustrated with defined boxes, it should be appreciated that in some implementations, such boxes are not visible to the player. It should also be appreciated that in some implementations, the symbol display areas are other shapes or not defined shapes and may not be associated with the reels 502A-502E. Further, it should be also appreciated that the game shown in the game screen 500 is merely representative and may have more or fewer game elements (e.g., reels, symbol display areas, symbols, gridlines, etc.) shown in the game screen 500.

As illustrated in FIG. 5C, the gaming system can display game symbols (e.g., game symbol 511A) and symbol values (e.g., symbol value 512A) for the first feature of the game in symbol display areas 510A-510O of the game reels 502A-502E. The gaming system can display the game symbols and symbol values in the symbol display areas 510A-510O of the game reels 502A-502E after the game reels 502A-502E spinning in FIG. 5B have stopped. The gaming system can randomly determine game symbols from the respective sets of symbols for the game reels 502A-502E (such as previously described with regard to block 417 in FIG. 4A). The gaming system can evaluate of the game symbols determined for the game reels 502A-502E for winning symbol combinations (such as previously described with regard to block 423 in FIG. 4B). As noted above, the player may have wagered on one or more pay lines (such as 20 pay lines shown in information area 505H). In some implementations, at least the active (wagered on pay lines) are evaluated for winning symbol combinations. Any suitable quantity of pay lines may be used to evaluate winning symbol combinations. It should be appreciated that the displayed combinations of game symbols shown in FIG. 5C are merely for explanatory purposes and the gaming system may randomly generate any suitable combination of game symbols based on defined sets of game symbols respectively associated with the reels 502A-502E.

FIG. 5C illustrates an example of the randomly-determined game symbols that may be displayed by the symbol display areas 510A-510O after the reels 502A-502E stop spinning. In the present example, the gaming system may evaluate the displayed game symbols and determine whether, based on a pay table, the symbol display areas 510A-510O of the 502A-502E include a winning combination of symbols corresponding to an award. (e.g., such as previously described with regard to blocks 421 and 423 in FIG. 4B). For example, active pay line 527A in FIG. 5C includes a winning combination of three adjacent symbols: Ace-Wild-Ace that, according to a pay table, corresponds to a predefined award (e.g., 100 credits). The gaming system may update the information area 505D to reflect the award or amount of credits (e.g., 100 credits) the player has won, if any, and may also update the player's gaming credit balance (e.g., in information area 505C) in accordance with the calculated award amount (e.g., 2080 credits) for the play of the game (such as previously described with regard to block 425 in FIG. 4B).

Further, the gaming system evaluates the symbol values associated with the game symbols displayed in FIG. 5C and determines an additional quantity of rounds for the second feature of the game (e.g., such as previously described with regard to blocks 429 and 433 in FIG. 4B). The additional quantity of rounds may be based on, for example, all the symbol values displayed on the game screen 500, only the symbol values included in active pay lines, only the symbol values in a winning pay line, or only the symbol values of game symbols included in a winning combination on an active pay line. For example, as shown in FIG. 5C, winning active pay line 527A includes game symbols Ace-Wild-Ace-10-Jack corresponding to symbol values 3-0-3-1-1 respectively. The gaming machine may determine a total for the symbol value (i.e., 8), which corresponds to a quantity of rounds for the second feature. The gaming device may indicate the quantity of rounds awarded in the round information area 526 (e.g., “8 Secondary Spins”) and update the quantity of secondary rounds (e.g., 18) in the second round indicator area 528 by combining the awarded quantity (e.g., 8) with the existing quantity (e.g., 10) (e.g., such as described with regard to block 433 in FIG. 4B).

In some implementations, the play of the first feature may end if the combination of game symbols displayed in FIG. 5C does not trigger the second feature (such as previously described with regard to block 433, “No” in FIG. 4B) and no rounds for the first feature remain (such as previously described with regard to block 463, “Yes” in FIG. 4D). For example, in an implementation in which the player's wager only provided a single round of the first feature (e.g., Primary Spins 1), the game may end in the event the first feature did not trigger the second feature. In some of such implementations, the player may continue the game (e.g., play another consecutive play of the game) by initiating another round of the game (such as previously described with regard to block 405 in FIG. 4A). That is, the player may place another wager and start a new play of the game within the current game session. However, continued game play may be dependent on the quantity of credits remaining in the player's credit balance (e.g., as displayed in information area 505C). The player may also choose to cash out (such as previously described with regard to block 467, “Yes” in FIG. 4D). In such an instance, the gaming system provides the player a value based on the player's credit balance (such as previously described with regard to block 469 in FIG. 4D).

FIG. 5D illustrates the game screen 500 that may occur in the event that the rounds for the first feature remain (such as previously described with regard to block 463, “No” in FIG. 4D) and the gaming system has initiated play of a second round of the first feature. As previously described with regard to FIG. 5B, the gaming system may cause the game screen 500 to display the game reels 502A-502E spinning prior to displaying the symbols for such game in the symbol display areas 510A-510O (e.g., at block 415 in FIG. 4A.). Indicative of the second round of the initially quantity (e.g., 3) provided for the first feature of the game, the gaming system may cause the round information area 526 to indicate information describing the current round (e.g., “Spin 2 of 3”) and decrement the first round indicator area 524 from “2” to “1.” As illustrated in FIG. 5E, the gaming system can display game symbols (e.g., game symbols 214) and corresponding symbol values in the symbol display areas 510A-510O of the game reels 502A-502E in a same or similar manner to that previously described with regard to FIG. 5C. Further, the gaming system can evaluate the games symbols for winning symbol combinations (such as previously described with regard to block 423 in FIG. 4B). Further, the gaming system evaluate symbol values and determines additional quantity of rounds for the second feature of the game (e.g., such as previously described with regard to blocks 429 and 433 in FIG. 4B).

FIG. 5E illustrates one example of the randomly-determined game symbols that may be displayed by the symbol display areas 510A-510O after the reels 502A-502E stop spinning in FIG. 5D. In this example, the game screen 500 includes winning active pay lines 527A and 527C. The pay line 527A includes game symbols, 10-10-10-Jack-Queen having a winning combination of three symbols, 10-10-10, and having corresponding symbol values 2-2-2-2-3 respectively. Additionally, the pay line 527C includes symbols, Sun-Sun-Sun-Queen-Jack having winning combination of symbols Sun-Sun-Sun and having corresponding symbol values of 0-0-0-3-2. In a same or similar manner to that described with regard to FIG. 5C, the gaming system can determine awards corresponding to the winning symbol combinations (e.g., 210 credits), display such credits in the information area 505D, and update the credit balance in gaming credit balance in information area 505C (e.g., 2290 credits). Further, the gaming machine may determine a combined (e.g., totaled) symbol value (i.e., 16), which corresponds to an additional quantity of rounds for the second feature, In the present example, the combined symbol value was determined by adding all of the symbol values included the winning active pay lines 527A and 527C. As previously described, in other implementations, the gaming system may only combine the symbol values of game symbols included in winning combinations and in active pay lines (e.g., 0 for the winning combination of Sun symbols in pay line 527C and 6 for the winning combination of 10 symbols in pay line 527A).

The gaming device may indicate the quantity of rounds awarded in the round information area 526 (e.g., “16 Secondary Spins”) and updated the quantity of secondary rounds (e.g., “34”) in the second round indicator area 528 by combining the awarded quantity (e.g., 16) with the existing quantity (e.g., 18) (e.g., such as described with regard to block 433 in FIG. 4B).

Notably, in FIG. 5E, the gaming system has incremented the symbol values (e.g., such as previously described with respect to block 465 in FIG. 4D) in the second round of the first feature in accordance with some implementations. That is, in the present example, the symbol values of the game symbols shown in FIG. 5C have been incremented by one. For example, the symbols 10, Jack, Queen, King, and Ace in FIG. 5C initially had respective values of 1, 1, 2, 2, and 3 in the first round of the first feature. In the second round of the first feature shown n FIG. 5E, the same symbols have values of 2, 2, 3, 3, and 4, respectively. Likewise, in a third round of the first feature, the symbol values of the same game symbols may be incremented to 3, 3, 4, 4, and 5, respectively.

As previously described above with regard to FIG. 5C, the play of the first feature may end if the combination of game symbols displayed in FIG. 5E does not trigger the second feature (such as previously described with regard to block 433 in FIG. 4B) and no rounds for the first feature remain. On the other hand, the game may not end if the gaming system evaluates the game symbols displayed in symbol display areas 510A-510O and determines that the symbol display areas 510A, 510B and 510C include bonus triggering symbols 513A, 513B, and 513C (e.g., as previously described with regarded to block 425 in FIG. 4B). For example, the sequence of triggering symbols 513A, 513B, and 513C across game reels 502A, 502B and 502C and along pay line 527C may trigger a second feature of the game (e.g., a bonus game) having multiple rounds. In some implementations, the gaming system may trigger the second feature when the symbol display areas 510A-510O display one or more of the bonus triggering symbols in one or more predetermined symbol display areas 510A-510O. For example, the gaming system may trigger a second feature when it determines that a bonus triggering symbol 513 is displayed in any one symbol display area, such as symbol display area 510A of the game screen 500, or in any one determined symbol display area. In some other implementations, the gaming system may trigger the second feature when the symbol display areas 510A-510O display a predetermined sequence or combination of bonus triggering symbols 513A, 513B, and 513C. For example, the gaming system can trigger a second feature when sequence of three adjacent bonus triggering symbols 513 appear on a wagered pay line or a single game reel (e.g., in symbol display areas 510A, 510F, and 510K of game reel 502A). Further, in some implementations, the bonus triggering symbols 513A, 513B, and 513C can correspond to an award of one or more free spins for the second feature, rather than triggering of the second feature providing a fixed quantity of free spins (e.g., 10 free spins). For example, each of the bonus triggering symbols 513A, 513B, and 513C can correspond to five free spins in the second feature. While not illustrated, it is understood that the bonus triggering symbols 513A, 513B, and 513C can include an indicator indicating a quantity of free spins associated with each of the symbols. Additionally, while the present example describes a game awarding free spins allowing play of a corresponding quantity of game rounds, it is understood that the quantity of rounds in some implementations are, instead, based on the wager received from the player (e.g., at block 405 in FIG. 4A), based on an additional wager received from the player for the second feature, or based on a random selection from a range (e.g., such as previously described with regard to block 427 in FIG. 4B).

In the example illustrated in FIG. 5E, the Sun symbol is a trigger symbol and the predetermined combination of Sun-Sun-Sun, as in pay line 527C, triggers the second feature. Such symbols are merely used for example and it is understood that the gaming system can user other symbols or indicators as a trigger symbol. In some implementations, the first feature may end in the event the second feature is triggered. As such, the player may not accumulate rounds of the second feature after triggering the second feature, even if the first round indicator area 524 indicates that additional rounds of the first feature remain. It is understood that, in some implementations, the gaming system may permit the first round to continue after triggering the second feature until all rounds of the first feature are consumed.

After triggering the second feature and prior to displaying the symbols for such second feature in the symbol display areas 510A-510O, the gaming system may cause the game screen 500 to display the reels 502A-502E spinning for a first round of the second feature game. For example, as represented by the dashed lines in FIG. 5F, the gaming system may show a display of spinning reels for each of the reels 502A-502E, in a same or similar manner to that described above with regard to FIG. 5B. Additionally, the gaming system can cause the round information area 526 to indicate information regarding the current round (e.g., “Spin 1 of 34”) and can decrement the second round indicator area 528 to that one round of the maximum rounds has been consumed (e.g., “33” instead of “34”).

As illustrated in FIG. 5G, the gaming system can display game symbols in symbol display areas 510A-510O of the game reels 502A-502E for the second feature triggered by the triggering symbols 513 in FIG. 5E. The gaming system can display the symbols in the symbol display areas 510A-510O of the reels 502A-502E in replacement of the symbols displayed in FIG. 5C after the reels 502A-502E have stopped spinning in FIG. 5F. The gaming system can randomly determine game symbols from associated sets of game symbols for the reels 502A-502E (such as previously described with regard to block 433 in FIG. 4B) and display the game symbols in the symbol display areas 510A-510O (such as previously described with regard to block 435 in FIG. 4B). The sets of game symbols can be the same or different than those used for FIGS. 5A-5E.

The gaming system can evaluate the game symbols determined for the reels 502A-502E for winning symbol combinations (such as previously described with regard to block 443 in FIG. 4C). The winning symbol combinations can be determined based on one or more pay tables (e.g., pay tables 215), which can be the same or different than those used for the first feature. As noted above, the player may have wagered on one or more pay lines (such as 20 pay lines shown in information area 505H). In some implementations, at least the active pay lines (e.g., wagered pay lines) are evaluated for winning symbol combinations. For example, FIG. 5E illustrates an example of a winning sequence of game symbols (“7-7-7”) in pay line 527A, which provide a predefined award (e.g., 75 credits). Any suitable quantity of pay lines may be used to evaluate winning symbol combinations. It should be appreciated that the displayed symbol combinations shown in FIG. 5E are merely for explanatory purposes and the gaming system may randomly generate any suitable combination of symbols based on defined sets of game symbols associated with the reels 502A-502E.

As illustrated in FIG. 5H, the gaming system can initiate a second spin of the second feature prior to displaying the symbols in the symbol display areas 510A-510O by causing the game screen 500 to display the reels 502A-502E spinning, as represented by the dashed lines in FIG. 5F in a same or similar manner to that described above with regard to FIG. 5B. Additionally, the gaming system can display a round information area 526 displaying a current count of the current spin in the awarded quantity of rounds (e.g., “Spin 2 of 10”).

As illustrated in FIG. 5I, the gaming system can determine, display, and evaluate game symbols for the second round of the second feature in a same manner as describe above with regard to FIG. 5E. For example, in the present example, the gaming system may determine that symbol display areas 510K, 510L, and 510M display winning sequences of three “Grape” symbols and three “Cherry” symbols along the active pay lines 527C and 527B, respectively, which may, for example, pay awards (e.g., 150 credits). The gaming system may display an indication of the awards in information area 505D and updated the player's gaming credit balance 505C, as previously described above. Additionally, in some implementations, the gaming system determines and displays one or more persistent game symbols or indicators. For example, in FIG. 5G, additional persistent symbol 529K determined for the second spin is displayed at symbol display area 510K.

The gaming system may iteratively repeat a number of rounds (e.g., spins) of up to the maximum quantity of rounds determined for the secondary feature (e.g., 34). Over the number of rounds, the gaming system may accumulate additional awards from winning combinations of game symbols, as indicated in information 505D of FIG. 5J (e.g., showing 4525 credits, which is increased from the 2205 credits in FIG. 5I). As illustrated in FIG. 5H, the second round indicator area 528 shows the current spin is the 34th spin of 34 spins (e.g. “Spin 34 of 34”).

As illustrated in FIG. 5K, the gaming system can determine, display, and evaluate game symbols for the thirty-fourth round the second feature in a same manner as described above with regard to 5G and 5I. Additionally, the gaming system determined and displayed one or more persistent game symbols or indicators 529A, 529F, 529K, and 529J for the thirty-fourth spin of the second feature in a same manner as describe above with regard to FIGS. 5G and 5I. As previously described, persistent symbols or indicators remain locked in the symbol display areas 510A-510A and accumulate during the multiple plays of the second feature. For example, in FIG. 5K new persistent game symbol or indicator 529K determined for the tenth spin is displayed at symbol display area 510K, in addition to persistent game indicators 529A and 529F, which were locked at symbol display areas 510A, and 510F from the previous rounds of the second feature. As spin thirty four is the maximum round of the second feature, the gaming system may evaluate the persistent game symbols or indicators 529A, 529F, 529K, and 529J in the symbol display areas 510A-510O to determine a persistent award (e.g., “Jackpot”), which may be a bonus paid from a progressive bonus pool (e.g., using bonus server 303). In some implementations, the gaming system can determine the persistent indicator bonus award based on the quantity or arrangement of the persistent game symbols or indicators 529A, 529F, and 529K. For example, as illustrated in FIG. 5K, game reel 502A includes a sequence of three adjacent persistent game symbols or indicators 529A, 529F, and 529K that have accumulated over more than one round of the second feature. Additionally, in some implementations, the gaming system may pay a persistent indicator bonus award for individual persistent game symbols or indicators, such as adjacent persistent game symbol or indicator 529J.

The present disclosure is not to be limited in terms of the particular implementations described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “ a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

A number of implementations of the invention have been described. Various modifications may be made without departing from the spirit and scope of the invention. For example, various forms of the flows shown above may be used, with steps re-ordered, added, or removed. Accordingly, other implementations are within the scope of the following claims.

We claim:

1. A gaming system comprising:
a cabinet;
a display device, a player input device, a value acceptor, and a value dispenser supported by the cabinet,
a game controller supported by the cabinet and operably connected to the display device, the player input device, the value acceptor, the value dispenser, the game controller comprising a random number generator, a memory device, and a processor, wherein the memory device stores program instructions that, when executed by the processor, cause the gaming system to perform operations including:
establishing a credit balance based on a monetary value received by the value acceptor;
receiving, via the player input device, a wager for a first feature of a game using the credit balance;
determining, in the first feature using the random number generator, a plurality of game symbols for a plurality of symbol display areas, wherein the plurality of game symbols correspond, respectively, to a plurality of symbol values;
determining a quantity using the plurality of symbol values;
determining that the plurality of game symbols includes a trigger of a second feature of the game;
initiating the second feature based on the trigger, wherein the second feature comprises a plurality of rounds corresponding to the quantity determined using the plurality of symbol values of the first feature;
determining for the plurality of rounds of the second feature, using the random number generator, respective pluralities of game symbols for the plurality of symbol display areas;
determining one or more winning symbol combinations for the plurality of rounds of the second feature based on the respective pluralities of game symbols;
determining one or more awards for the second feature corresponding to the one or more winning symbol combinations; and
issuing value from the value dispenser based on the one or more awards upon receipt of a cash out request.

2. The gaming system of claim 1, wherein determining the quantity comprises summing the plurality of symbol values and a baseline value.

3. The gaming system of claim 2, wherein the operations further comprise determining the baseline value based on an amount of the wager.

4. The gaming system of claim 2, wherein:
the first feature comprises a second plurality of rounds; and
determining the quantity comprises summing the plurality of symbol values determined for the second plurality of rounds.

5. The gaming system of claim 2, wherein the operations further comprise determining a maximum quantity of rounds of the second feature based on the plurality of symbol values.

6. The gaming system of claim 1, wherein the operations further comprise determining the plurality of symbol values based on an amount of the wager.

7. The gaming system of claim 6, wherein determining the plurality of symbol values comprises randomly determining the plurality of symbol values.

8. The gaming system of claim 6, wherein determining the symbol values comprises increasing the symbol values during a gaming session, the gaming session including a plurality of games by a player at the gaming system.

9. The gaming system of claim 8, where increasing the symbol values comprises incrementing the symbol values based on a second wager received from the player via the player input device.

10. The gaming system of claim 1, wherein determining the quantity comprises summing the plurality of symbol values included in an active pay line.

11. The gaming system of claim 1, wherein determining the quantity comprises summing the plurality of symbol values included in a winning combination within an active pay line.

12. A method of operating a gaming system comprising:
establishing, by a processor a credit balance based on a monetary value received by a value acceptor;
receiving, by the processor from a player input device, a wager for a game using the credit balance;
determining, in a first feature of the game using a random number generator, a plurality of game symbols for a plurality of symbol display areas, wherein the plurality of game symbols correspond, respectively, to a plurality of symbol values;
determining, by the processor, a quantity using the plurality of symbol values;
determining, by the processor, that the plurality of game symbols includes a trigger of a second feature of the game;
initiating, by the processor, the second feature based on the trigger, wherein the second feature comprises a plurality of rounds corresponding to the quantity determined using the plurality of symbol values of the first feature;
determining, by the processor using the random number generator, for the plurality of rounds of the second feature, respective pluralities of game symbols for the plurality of symbol display areas;
determining, by the processor, one or more winning symbol combinations for the plurality of rounds of the second feature based on the respective pluralities of game symbols;
determining, by the processor, one or more awards for the second feature corresponding to the one or more winning symbol combinations; and
issuing value, by the processor from a value dispenser, based on the one or more awards upon receipt of a cash out request.

13. The method of claim 12, wherein determining the quantity comprises summing the plurality of symbol values and a baseline value.

14. The method of claim 13, wherein:
the first feature comprises a second plurality of rounds; and
determining the quantity comprises summing the plurality of symbol values determined for the second plurality of rounds.

15. The method of claim 13, further comprising determining a maximum quantity of rounds of the second feature based on plurality of symbol values.

16. The method claim 12, further comprising determining the plurality of symbol values based on an amount of the wager.

17. The method of claim 12, further comprising increasing the symbol values during a gaming session, the gaming session including a plurality of games by a player at the gaming system.

18. The method of claim 17, where increasing the symbol values comprises incrementing the symbol values based on a second wager received from the player via the player input device using the credit balance.

19. The method of claim 12, wherein determining the quantity comprises summing the plurality of symbol values included in an active pay line.

20. A non-transitory computer-readable storage device having program instructions stored therein, the program instructions being executable by a processor to cause a gaming system to:
establish a credit balance based on a monetary value received by a value acceptor;
receive, from a player input device, a wager for a game using the credit balance;
determine, in a first feature of the game using a random number generator, a plurality of game symbols for a plurality of symbol display areas, wherein the plurality of game symbols correspond, respectively, to a plurality of symbol values;
determine a quantity using the plurality of symbol values;
determine that the plurality of game symbols includes a trigger of a second feature of the game;
initiate the second feature based on the trigger, wherein the second feature comprises a plurality of rounds corresponding to the quantity determined using the plurality of symbol values of the first feature;
determine for the plurality of rounds of the second feature, using the random number generator, respective pluralities of game symbols for the plurality of symbol display areas;
determine one or more winning symbol combinations for the plurality of rounds of the second feature based on the respective pluralities of game symbols;
determine one or more awards for the second feature corresponding to the one or more winning symbol combinations; and
issue value from a value dispenser based on the one or more awards upon receipt of a cash out request.
